(19) United States
(12) Patent Application Publication
(10) Pub. No.: US 2026/0310538 A1
(43) Pub. Date: Oct. 8, 2026

(54) SYSTEMS AND METHODS FOR AUTOMATED REVERSE EVENT DETECTION

(71) Applicant: Panasonic Well LLC, Palo Alto, CA (US)

(72) Inventor: Ramin Firoozye, San Francisco, CA (US)

(21) Appl. No.: 19/276,082

(22) Filed: Jul. 22, 2025

Related U.S. Application Data
(60) Provisional application No. 63/783,806, filed on Apr. 4, 2025.

(51) Int. Cl. G06F 11/07

(52) U.S. Cl. CPC G06F 11/079; G06F 11/0709

(57) ABSTRACT

Systems and methods for automatically and continuously evaluating user data collected through different devices and sensors to perform root-cause analysis and identify any causes of present events or anomalies are provided. A user monitoring system continuously processes ambient data associated with a user to detect a predictive anomaly associated with the user. The user monitoring system processes the ambient data and historical data associated with the user to identify one or more root-causes of the anomaly. The user monitoring system transmits a notification corresponding to the one or more root-causes and the predictive anomaly to a set of recipients. The user monitoring system monitors new ambient data associated with the data to determine whether the anomaly has been resolved.

### CROSS-REFERENCE TO RELATED APPLICATIONS

The present patent application claims the priority benefit of U.S. provisional patent application number 63/783,806 filed Apr. 4, 2025 and is related to U.S. Patent Applications entitled “CONTINUOUS SENSOR MONITORING FOR IDENTIFICATION OF PREDICTIVE ANOMALIES” (Attorney Docket No.: 109304-845021-008300US) filed Jul. 22, 2025, “AUTOMATED DISAMBIGUATION OF USERS IN A MULTI-TENANT ENVIRONMENT BASED ON SENSOR DATA” (Attorney Docket No.: 109304-845004-008400US) filed Jul. 22, 2025 and “DETECTING AND TRANSMITTING EVENTS ASSOCIATED WITH A SUBJECT” (Attorney Docket No.: 109304-845006-008500US) filed Jul. 22, 2025, U.S. Provisional Application 63/783,800 filed Apr. 4, 2025 entitled “CONTINUOUS SENSOR MONITORING FOR IDENTIFICATION OF PREDICTIVE ANOMALIES”, U.S. Provisional Application 63/783,809 filed Apr. 4, 2025 entitled “AUTOMATED DISAMBIGUATION OF USERS IN A MULTI-TENANT ENVIRONMENT BASED ON SENSOR DATA” and U.S. Provisional Application 63/783,798 filed Apr. 4, 2025 entitled “DETECTING AND TRANSMITTING EVENTS ASSOCIATED WITH A SUBJECT”, the disclosures of which are incorporated herein by reference in its entirety for all purposes.

### FIELD

The present disclosure relates to systems and methods for automatically and continuously evaluating user data collected through different devices and sensors to perform root-cause analysis and identify any causes of present events or anomalies.

### SUMMARY

Disclosed embodiments provide a framework for automatically and continuously evaluating user data that is collected through different devices and sensors and, based on this user data, performing root-cause analysis to identify any causes of different events and/or anomalies. According to some embodiments, a computer-implemented method is provided. The computer-implemented method comprises continuously receiving ambient data associated with a user. The ambient data is continuously received through a set of communications channels between different sensors and a gateway device. The computer-implemented method further comprises obtaining an anomaly notification corresponding to an anomaly associated with the user. The anomaly notification indicates a current user state for which a root-cause is unknown. The computer-implemented method further comprises processing the ambient data and historical ambient data associated with the user through a machine learning algorithm to identify one or more root-causes of the anomaly. The machine learning algorithm is trained using a dataset of sample ambient data, sample anomalies, and sample root-causes associated with the sample anomalies. The computer-implemented method further comprises transmitting a root-cause notification corresponding to the one or more root-causes. When the root-cause notification is received by one or more recipients, the one or more recipients perform one or more actions to address the anomaly according to the one or more root-causes. The computer-implemented method further comprises continuously monitoring new ambient data associated with the user to determine whether the one or more actions have addressed the anomaly and the one or more root-causes.

In some embodiments, the computer-implemented method further comprises anonymizing the ambient data and the historical ambient data to generate anonymized data. The computer-implemented method further comprises dynamically updating the dataset to incorporate the anonymized data. The updated dataset is used to update the machine learning algorithm.

In some embodiments, the one or more recipients include a device. The device is connected to the gateway device through a wireless communications channel. Further, the root-cause notification includes one or more executable instructions that, when executed by the device, cause the device to perform the one or more actions.

In some embodiments, the computer-implemented method further comprises determining, based on the new ambient data, that the one or more actions have not addressed the anomaly. The computer-implemented method further comprises transmitting a new notification to indicate that the anomaly has not been addressed. The new notification includes the new ambient data.

In some embodiments, the computer-implemented method further comprises determining, based on the new ambient data, that the one or more actions have not addressed the anomaly. The computer-implemented method further comprises identifying new actions performable to address the anomaly.

In some embodiments, the anomaly notification is obtained through a medical entity associated with the user.

In some embodiments, the different sensors include a set of Internet-of-Things (IoT) devices associated with the user.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a root-cause analysis system dynamically processes ambient data corresponding to different devices and sensors in a user environment in response to a detected user anomaly to identify one or more root-causes of the user anomaly in accordance with at least one embodiment;

FIG. 2 shows an illustrative example of an environment in which a root-cause determination module of a root-cause analysis system dynamically processes event data corresponding to a user anomaly and historical data corresponding to the user to identify one or more root-causes of the user anomaly in accordance with at least one embodiment;

FIG. 3 shows an illustrative example of an environment in which a root-cause determination algorithm dynamically processes event data corresponding to a detected user anomaly and historical data corresponding to the user to identify a root-cause of the user anomaly and transmit notifications corresponding to the identified root-cause to different recipients in accordance with at least one embodiment;

FIG. 4 shows an illustrative example of an environment in which a user monitoring system implemented by a user monitoring gateway automatically determines a root-cause for a detected user anomaly in accordance with at least one embodiment;

FIG. 5 shows an illustrative example of an environment in which a root-cause determination algorithm implemented on a user monitoring gateway dynamically processes event data corresponding to a detected user anomaly and historical data corresponding to the user to identify a root-cause of the user anomaly and transmit notifications corresponding to the identified root-cause to different recipients in accordance with at least one embodiment;

FIG. 6 shows an illustrative example of a process for identifying a root-cause of a detected user anomaly within a user environment and generating actions for addressing the detected user anomaly in accordance with at least one embodiment;

FIG. 7 shows an illustrative example of an environment in which communications with members are processed in accordance with at least one embodiment; and

FIG. 8 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically identify and recommend tasks to a member of a task facilitation service in order to reduce the member's cognitive load. Through this framework, the task facilitation service can monitor communications between a member and an assigned representative to automatically identify possible tasks that can be performed for the benefit of the member. Further, the task facilitation service can automatically identify any additional information that may be required for the creation of these tasks. Once these tasks have been created, the task facilitation service can coordinate with the representative and/or third-party services to perform these tasks for the benefit of the member.

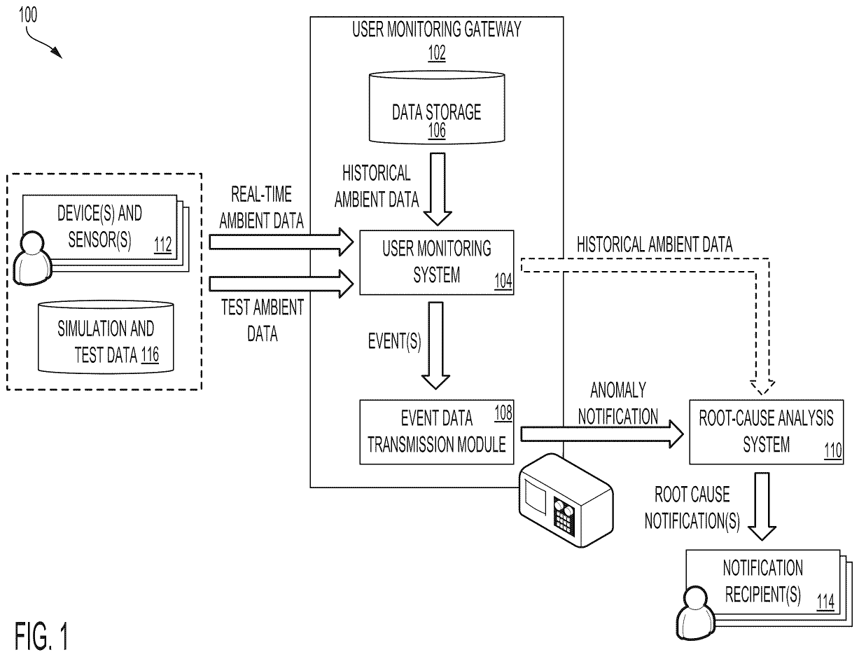

FIG. 1 shows an illustrative example of an environment 100 in which a root-cause analysis system 110 dynamically processes ambient data corresponding to different devices and sensors 112 in a user environment in response to a detected user anomaly to identify one or more root-causes of the user anomaly in accordance with at least one embodiment. In the environment 100, a user monitoring gateway 102 may be implemented to dynamically, and in real-time or near real-time, monitor ambient data from different devices and sensors 112 implemented within a user environment to detect events associated with a user within the user environment (such as the user's home or any other location where the user monitoring gateway 102 is implemented). For instance, in an embodiment, the user monitoring gateway 102 is configured and implemented to automatically process ambient data from myriad devices and sensors 112 within a user environment to track the health and wellbeing of a particular user within the user environment. As an illustrative example, the user monitoring gateway 102 may continuously process ambient data from the myriad devices and sensors 112 within the user environment to detect any medical emergencies and accordingly transmit notifications to entities (e.g., medical personnel, caregivers, etc.) that may be able to address these medical emergencies. Further, the user monitoring gateway 102 may continuously process the ambient data from the myriad devices and sensors 112 to monitor user activities within the user environment. For instance, the user monitoring gateway 102 may process this ambient data to dynamically track user movements and location within the user environment, track user activities within the user environment (e.g., eating, exercising, performing hygienic tasks, sleeping, etc.), and the like.

In an embodiment, the user monitoring gateway 102 transmits event data corresponding to a particular event detected within the user environment and associated with a particular user to different entities based on the type or category of the particular event. The event data may be transmitted to these different entities based on a set of preferences corresponding to the particular user associated with the event. Returning to an illustrative example described above, if the particular event corresponds to a medical emergency associated with a user, the user monitoring gateway 102 may evaluate the user preferences associated with the user and determine that the data associated with the particular event (e.g., medical emergency) is to be transmitted to medical personnel which may be deployed to address the medical emergency. As another illustrative example, if the particular event corresponds to a user's lack of appetite (e.g., the user's eating habits have changed over a period of time, as detected by the user monitoring gateway 102), the user monitoring gateway 102 may evaluate the user preferences associated with the user and determine that the data associated with the particular event is to be transmitted to a caregiver associated with the user. The caregiver may use this data to further evaluate the user's eating habits and attend to the user to address the user's lack of appetite.

In some instances, the user monitoring gateway 102 may transmit event data corresponding to any detected events within the user environment to a remote user monitoring system (not shown) that may broadcast the event data to different instances of a user health monitoring application implemented on different computing devices. The remote user monitoring system may maintain different user records corresponding to different users associated with the remote user monitoring system through which event data associated with these different users may be tracked and stored. The remote user monitoring system, in some instances, may provide user monitoring services for various users within different environments. For example, the remote user monitoring system may automatically coordinate with different user monitoring gateways (such as user monitoring gateway 102) to detect any user predictive anomalies that may be indicative of different issues related to a user (e.g., a medical emergency, a new medical condition, a need for assistance, etc.). Further, the remote user monitoring system may automatically coordinate with different user monitoring gateways to dynamically track user activities within these different environments to generate user baselines that may be used to detect, in real-time or near real-time, the aforementioned user predictive anomalies. In some instances, the remote user monitoring system may further coordinate communication with identified entities according to user preferences as defined during an onboarding process and/or through interaction with the user health monitoring application or with a web portal implemented by the remote user monitoring system.

The user monitoring gateway 102, in an embodiment, is a standalone computing device that is configured to interact with different devices and sensors 112 through corresponding communications channels to obtain and process ambient data within a user environment to detect and categorize different events occurring within the user environment. For example, the user monitoring gateway 102 may be connected to one or more Internet-of-Things (IoT) devices within the user environment. These connections (i.e., communications channels) may be established according to one or more IoT protocols. Example IoT protocols that may be implemented to facilitate the connections between the myriad IoT devices within the user environment and the user monitoring gateway 102 may include, but are not limited to, the Advanced Message Queuing Protocol (AMQP), Bluetooth®, Bluetooth® Low Energy (BLE), Matter, the Constrained Application Protocol (CoAP), the Data Distribution Service (DDS) protocol, LoRaWAN, Lightweight Machine-to-Machine (LWM2M) protocol, Message Queuing Telemetry Transport (MQTT), Wi-Fi, HTTP/HTTPS, websockets, and the like. IoT devices that may be implemented in a user environment may include, but are not limited to, home security devices (e.g., doorbell cameras, smart locks, alarm systems, etc.), home appliances (e.g., smart refrigerators, smart lights, smart televisions, smart speakers, smart washers and dryers, etc.), data streaming devices (e.g., audio, video, etc.), embedded devices (e.g., pacemakers, subcutaneous sensors, etc.), devices both wired and wireless (e.g., glucose monitors, glucose pumps, etc.), imaging sensors (e.g., passive infrared (PIR) sensors, ultrasound sensors, infrared sensors, environmental sensors, etc.), and the like.

The user monitoring gateway 102 may additionally be connected to one or more sensors within the user environment and through which the user monitoring gateway 102 may dynamically obtain ambient data. These one or more sensors may include, but are not limited to, home temperature sensors, air quality sensors, water monitoring sensors (e.g., leak detectors, water quality sensors, etc.), motion sensors, light sensors, door and window sensors, and the like. The one or more sensors may be connected to the user monitoring gateway 102 through one or more communications protocols, including any of the IoT protocols described above or other available communications protocols. Additionally, these one or more sensors may include audial sensors, ultrasound sensors, mmWave sensors, presence sensors, and the like. In some instances, the one or more sensors may be implemented on one or more of the IoT devices described above (e.g., a light sensor implemented on a smart television to determine a desired television brightness, a door sensor implemented on a smart refrigerator for detecting when the smart refrigerator is accessed, an air quality sensor implemented on a smart air conditioning/heating system, etc.). Thus, in some instances, the ambient data obtained from one or more sensors 112 may be included within the ambient data obtained from one or more IoT devices. In some instances, the ambient data from one or more sensors may be provided through standalone communications channels established between the user monitoring gateway 102 and these one or more sensors.

The user monitoring gateway 102 may further obtain ambient data through one or more cameras implemented within the user environment. These cameras may continuously, or in response to a triggering event, collect audiovisual data within and without the user environment. For example, the user environment may include a doorbell camera that may automatically record audiovisual data when a user is detected within a pre-defined range of the doorbell camera and/or when a user interacts with the doorbell camera. As another illustrative example, the user environment may include one or more cameras within different rooms that may automatically record audiovisual data when a user within the user environment enters any of these different rooms. In some instances, a camera within the user environment may be configured to automatically record any audiovisual data in the event of any sudden change in movement of a detected user within range of the camera. For example, if a camera detects a user within a particular room and the user suddenly falls to the ground (e.g., slips, faints, etc.), the camera may automatically detect this sudden fall and record the user. In some instances, the one or more cameras within the user environment may transmit any recorded audiovisual data to the user monitoring gateway 102 continuously or in response to a triggering event (such as the triggering events described above). The one or more cameras may be connected to the user monitoring gateway 102 through one or more communications protocols, including any of the IoT protocols described above or other available communications protocols. For instance, the one or more cameras may be implemented on one or more of the IoT devices described above. Alternatively, one or more cameras may be standalone devices through which standalone communications channels may be established with the user monitoring gateway 102.

The myriad devices and sensors 112 may further include personal devices associated with a user within the user environment associated with the user monitoring gateway 102. These personal devices may include, but are not limited to, smartphones, tablet computing devices, wearable devices (e.g., personal fitness tracking devices, smart watches, smart eyewear, augmented reality devices, etc.), embedded devices, and the like. Embedded devices may include permanent devices that are surgically implanted (e.g., pacemakers, cochlear implants, etc.), semi-permanent devices (e.g., medical devices designed to be removed, etc.), and temporal devices (e.g., sensors designed to be ingested and pass through the human body, etc.). These personal devices may be connected to the user monitoring gateway 102 through any of the communications protocols described herein. In an embodiment, when a user establishes a communications channel between a user's personal device and the user monitoring gateway 102, the user monitoring gateway 102 automatically associates the user's personal device with the particular user.

In an embodiment, the user monitoring gateway 102 implements a user monitoring system 104 that continuously, and in real-time or near real-time, obtains ambient data associated with the user environment from the various devices and sensors 112 implemented in the user environment. The user monitoring system 104 may comprise one or more computer systems of the user monitoring gateway 102 or may be implemented as an application or process executing on the user monitoring gateway 102. In some instances, the user monitoring system 104 may be implemented through various special-purpose components of the user monitoring gateway 102 that can facilitate real-time or near real-time collection and processing of different ambient data from any number of different devices and sensors 112 within the user environment and as the ambient data from these different devices and sensors is received.

In an embodiment, the user monitoring system 104 implements a set of libraries or other resources corresponding to different data formats utilized by different devices and sensors 112 compatible with the user monitoring gateway 102. For instance, the ambient data generated and transmitted by the myriad devices and sensors 112 within a user environment and connected to the user monitoring gateway 102 through different communications channels may be constructed using different data structures. The user monitoring system 104 may maintain a set of libraries or other resources that indicate these different data structures according to the types of devices and sensors from which the user monitoring gateway 102 may be connected to. For instance, the user monitoring system 104 may include one or more JavaScript Object Notation (JSON) libraries, Concise Binary Object Representation (CBOR) libraries, Binary JSON (BSON) libraries, Extensible Markup Language (XML) libraries, Comma-Separated Values (CSV) libraries, Matter libraries, remote procedure call (RPC) libraries (e.g., gRPC, etc.), Protocol Buffers (ProtoBuf) mechanisms, Real-Time Messaging Protocol (RTMP) libraries, HTTP Live Streaming (HLS) libraries, Real-Time Streaming Protocol (RTSP) libraries, Secure Reliable Transport (SRT) libraries, maximum segment size (MSS), Web Real-Time Communication (WebRTC) libraries, compressed, minimized, encrypted text or binary, uni-directional, bi-directional, unicast, and multi-cast mechanisms, and the like. Additionally, the user monitoring system 104 may implement a set of libraries or other resources for processing semi-structured and unstructured data from different devices and sensors 112 within the user environment. For instance, the user monitoring system 104 may implement computer vision or other machine learning algorithms that are dynamically trained to process audiovisual data from different devices and sensors 112 within the multi-tenant environment to automatically identify various characteristics associated with the audiovisual data (e.g., user(s) within a room, voice signatures, etc.). As another illustrative example, the user monitoring system 104 may receive telemetry data or other IoT output from the one or more devices and sensors 112 that is unstructured and may necessitate format-specific algorithms or other processes for evaluating the telemetry data or other IoT output.

In an embodiment, the user monitoring gateway 102 implements a data storage repository 106 that is configured to store real-time ambient data from the myriad devices and sensors 112 in the user environment. For instance, as ambient data is obtained from the myriad devices and sensors 112 within the user environment, the user monitoring system 104 may redundantly store this ambient data within the data storage repository 106. The ambient data may be stored in the data storage repository 106 in conjunction with corresponding timestamps that may denote the time at which the ambient data was generated by the different devices and sensors 112. In some instances, the data storage repository 106 may store ambient data from the myriad devices and sensors 112 for a limited period of time (e.g., one week, one month, one year, etc.) to prevent a data overflow within the user monitoring gateway 102. In an embodiment, and as described in greater detail herein, if the user monitoring system 104 detects that the data storage repository 106 has reached a maximum storage amount threshold, the user monitoring system 104 can anonymize this archival ambient data from the data storage repository 106 and provide this anonymized ambient data to a root-cause analysis system 110 for persistent storage and use. This may prevent the aforementioned data overflow within the user monitoring gateway 102 and ensure that there persists a requisite or threshold amount of storage to support real-time ambient data collection and storage. By implementing these controls, the user monitoring gateway 102 is able to continuously obtain and process real-time ambient data to detect ongoing events within a user environment.

In an embodiment, the user monitoring system 104 implements and dynamically trains a machine learning algorithm or artificial intelligence to detect any activities or other events associated with a user within the user environment. In some instances, the observed events may be routine for the user associated with the user monitoring gateway 102. As an illustrative example, the user may be known to routinely eat breakfast between 8:00 A.M. and 8:45 A.M. each day. Further, the user may be known to routinely move from their bedroom within the user environment to a bathroom between 7:00 A.M. and 7:15 A.M. for personal hygiene and to get ready to start their day. The user monitoring system 104 may further detect, from the ambient data, particular events that may not be related to a routine activity within the user environment. For example, through the aforementioned machine learning algorithm or artificial intelligence, the user monitoring system 104 may detect an event corresponding to a possible incident within the user environment that is not routine, such as an accident within the user environment. Further, through the aforementioned machine learning algorithm or artificial intelligence, the user monitoring system 104 may detect the absence of ambient data corresponding to different activities within the user environment. As an illustrative example, if ambient data corresponding to a particular room within the user environment is not representative of the presence of a user and/or of an activity occurring within the room, the user monitoring system 104 may generate synthetic data corresponding to the lack of activity within the room. This lack of activity, in some instances, may be indicative of a deviation from routine activities and movements within the user environment and, thus, may be indicative of an issue with the user within the user environment.

The machine learning algorithm or artificial intelligence implemented by the user monitoring system 104 may be dynamically trained using supervised, unsupervised, or hybrid training techniques. For instance, a dataset of sample ambient data (e.g., historical ambient data, hypothetical or artificial ambient data, combinations of historical and hypothetical/ambient data, etc.) and sample events (e.g., known events associated with the historical ambient data, hypothetical/artificial events associated with the hypothetical/artificial ambient data, combinations of known and hypothetical/artificial events, etc.) may be analyzed using a clustering or classification algorithm to classify the sample ambient data according to a set of different classifications (e.g., events). For instance, the machine learning algorithm or artificial intelligence may be dynamically trained in real-time by converting the sample ambient data into a set of embeddings and the sample events into a set of event embeddings. The machine learning algorithm or artificial intelligence may classify the sample ambient data according to one or more vectors of similarity between the set of embeddings and the set of event embeddings. In some instances, the machine learning algorithm or artificial intelligence may be implemented with a threshold that may be used to determine, based on the aforementioned embeddings and the one or more vectors of similarity, whether sample ambient data is sufficiently similar (e.g., satisfies the threshold by having a requisite amount of embeddings being within a level of tolerance of corresponding event embeddings for a particular known event) to a particular sample event.

In an embodiment, the machine learning algorithm or artificial intelligence implemented by the user monitoring system 104 is further trained using simulated and/or test ambient data from a simulation and test data repository 116. The simulated and/or test ambient data used to dynamically train or fine-tune the machine learning algorithm or artificial intelligence may include hypothetical or artificial ambient data corresponding to different devices and/or sensors that may be implemented in the user environment or that are otherwise compatible with the user monitoring gateway 102. In some instances, the simulated and/or test ambient data from the simulation and test data repository 116 may include raw sensor and device data from different devices and/or sensors implemented in different testing environments and that are implemented in these different testing environments to generate synthetic, simulated, and/or replay data. This simulated and/or test ambient data from the simulation and test data repository 116 may be used to enhance or supplement the dataset used to dynamically train and fine-tune the machine learning algorithm or artificial intelligence implemented by the user monitoring system 104. Through this continuous training process, the machine learning algorithm or artificial intelligence is enhanced to reduce the likelihood of the machine learning algorithm or artificial intelligence erroneously or falsely identifying anomalous events within the user environment during user performance of routine activities (e.g., false positives). Similarly, this continuous training process may reduce the likelihood of the machine learning algorithm or artificial intelligence failing to detect anomalous events within the user environment (e.g., false negatives).

In an embodiment, through the machine learning algorithm or artificial intelligence, the user monitoring system 104 may perform such clustering or classification of ambient data from different devices and sensors 112 in the user environment in real-time or near real-time as the ambient data is received. Through this processing of the ambient data, the user monitoring system 104 may obtain partial matches among different known events to detect an event occurring within the user environment. Example classification and/or clustering algorithms that may be implemented include Support Vector Machines (SVM), k-Nearest Neighbor (KNN) algorithms, density-based spatial clustering of applications with noise (DBSCAN) algorithms, Hidden Markov Models, logistic regression algorithm, random forest models, Naïve Bayes models, linear regression models, decision tree models, gradient boosting machine models, and the like. In some instances, activities or other events associated with a user within the user environment may be detected by processing the ambient data through heuristic and/or statistics-based algorithms or sub-systems.

In an embodiment, the user monitoring system 104 automatically selects the method for processing the ambient data based on one or more factors. For example, if the user monitoring system 104 detects that it is encountering significant latency issues due to unstable network connectivity, the user monitoring system 104 may automatically process received ambient data through heuristic and/or statistics-based algorithms or sub-systems that require less computational and network resources in order to detect possible activities or other events associated with a user within the user environment. As another example, the user monitoring system 104 can automatically select a method for processing ambient data based on cost considerations, whereby the user monitoring system 104 may estimate the cost (e.g., energy costs, etc.) of processing ambient data in order to detect different activities or other events within the user environment and, based on this cost, select an appropriate method for processing the ambient data. Thus, the utilization of computational and network resources associated with the user monitoring system 104 is optimized according to the conditions within the user environment such that unnecessary and/or extraneous resources are invoked for processing of the ambient data.

As the user monitoring system 104 generates event data corresponding to different user events, the user monitoring system 104 may provide this event data to an event data transmission module 108 implemented by the user monitoring gateway 102. The event data transmission module 108 may be implemented as an application or process executing on the user monitoring gateway 102 and is configured to process event data provided by the user monitoring system 104 to detect any possible user predictive anomalies that may denote one or more issues associated with the user within the user environment. In some instances, the event data transmission module 108 may be implemented through various special-purpose components of the user monitoring gateway 102 that can facilitate real-time or near real-time processing of event data corresponding to different events to identify any user predictive anomalies and to notify one or more entities according to the types of user predictive anomalies detected and any user preferences.

A user predictive anomaly is an event that corresponds to a current user state and represents a deviation from a user's baseline or routine activities, behaviors, physiological state, or other attribute. For example, if a user is known to exhibit an average blood pressure of 130/90 mm Hg and a pulse of 145 beats per minute (bpm), a user predictive anomaly may be detected if the user's blood pressure and pulse increases significantly beyond these averages (e.g., 170/120 mm Hg and 205 bpm, etc.) without any other catalyst (e.g., the user is not engaged in a rigorous exercise, the user is sleeping, etc.). Further, a user predictive anomaly may be detected if these changes occur suddenly (e.g., within a minute, within a few seconds, etc.). As another illustrative example of a user predictive anomaly, if a user is associated with a known voice signature, a deviation from this known voice signature (such as if the user is slurring their words, having difficulty speaking, etc.) may represent a user predictive anomaly requiring additional evaluation. Thus, user predictive anomalies may represent motor control issues, cognitive issues, physical degradation, or other user physiological issues that may require additional attention. When the predictive anomaly is initially detected, the one or more root-causes of the predictive anomaly may be unknown. Thus, the factors leading to the current user state and the predictive anomaly may need to be determined in order to identify and address the root-causes of the predictive anomaly.

In some instances, predictive anomalies may be associated with different devices and/or sensors 112 within the user environment and/or the user monitoring gateway 102 itself. For example, if the user environment includes a camera that continuously transmits audiovisual data to the user monitoring gateway 102 for processing, the absence of such audiovisual data over a period of time may represent a predictive anomaly that may correspond to an issue with the camera. As another illustrative example, if a blood glucose monitor transmits, to the user monitoring gateway 102, blood glucose readings that are highly variable (e.g., readings obtained over a few seconds show high variability, etc.), this high variability may represent a predictive anomaly that can be indicative of an issue with the blood glucose monitor or in the use of the blood glucose monitor by the user. In some instances, the user monitoring gateway 102 automatically generates device data specific to the user monitoring gateway 102 that may be used to determine the present operating state of the user monitoring gateway 102. As described in greater detail herein, the absence of such data may represent a predictive anomaly associated with the user monitoring gateway 102 that may be indicative of a particular issue affecting the performance of the user monitoring gateway 102.

In an embodiment, the event data transmission module 108 implements a machine learning algorithm or artificial intelligence that is dynamically trained to evaluate data corresponding to different events occurring within a user environment to detect any predictive anomalies associated with a user. This machine learning algorithm or artificial intelligence may be dynamically trained using supervised, unsupervised, or hybrid training techniques. For instance, a dataset of sample event data (e.g., historical data corresponding to previously detected events, hypothetical data corresponding to artificial events, combinations of historical and hypothetical data, etc.), sample user data (e.g., baseline information corresponding to known users, hypothetical baseline information for hypothetical users, combinations of actual and hypothetical baseline information, etc.), and sample predictive anomalies corresponding to the sample event data and sample user data may be analyzed using the machine learning algorithm or artificial intelligence to identify any correlations between the sample predictive anomalies and any deviations between the sample event data and the sample user data for each data point in the dataset. Based on these correlations, the machine learning algorithm or artificial intelligence may be dynamically trained to associate different deviations between event data and user data with particular types or categories of predictive anomalies. For instance, based on the type of event data obtained and the deviations between the event data and the user data, the machine learning algorithm or artificial intelligence may classify the event data according to one or more vectors of similarity between the event data and different types or categories of predictive anomalies.

To implement the machine learning algorithm or artificial intelligence used to detect any predictive anomalies from obtained event data, the event data transmission module 108 may generate an initial iteration of the machine learning algorithm or artificial intelligence. For instance, the event data transmission module 108 may initialize a set of coefficients {α1, α2, α3, . . . αn} randomly according to a Gaussian distribution or non-Gaussian distribution. Using this initial iteration of the machine learning algorithm or artificial intelligence, the event data transmission module 108 may process the dataset of sample event data to generate an output. This output may specify, for each data point corresponding to a particular set of event data, any identified predictive anomalies associated with a sample user and/or with sample sensors and/or devices within a user environment. The event data transmission module 108 may compare the output generated using the initial iteration of the machine learning algorithm or artificial intelligence to the sample vector values defined in the dataset for each of the data points (e.g., sample ambient data) to identify any inaccuracies or other errors. If the output of the machine learning algorithm or artificial intelligence does not satisfy one or more criteria, the event data transmission module 108 may iteratively update one or more coefficients of the set of coefficients to generate an updated machine learning algorithm or artificial intelligence. The updated machine learning algorithm or artificial intelligence may be used to process the aforementioned training dataset, as well as any additional data points or other datasets obtained by the user monitoring gateway 102 to generate a new output for each data point in the training dataset. The event data transmission module 108 may use this updated machine learning algorithm or artificial intelligence to process the available data points and generate a new output (e.g., new identifications of predictive anomalies based on the sample event data included in the dataset, etc.). The event data transmission module 108 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria for identifying predictive anomalies from obtained event data.

In an embodiment, once the event data transmission module 108 has categorized the event data according to the identified predictive anomaly or, if no predictive anomaly was identified, according to the identified event classification, the event data transmission module 108 may determine how to route the event data to other entities. For example, if the event data corresponds to a predictive anomaly that requires immediate medical attention (e.g., sudden changes to a user's blood pressure and/or pulse, detection of user losing consciousness, sudden slurring of speech, etc.), the event data transmission module 108 may evaluate the user preferences associated with the user and determine that the event data is to be transmitted to medical personnel which may be deployed to address the possible medical emergency. As another illustrative example, if the event data corresponds to a predictive anomaly associated with the user's eating habits (e.g., the user is exhibiting a loss of appetite, the user is experiencing stomach discomfort when eating, the user is regurgitating any ingested food, etc.), the event data transmission module 108 may evaluate the user preferences associated with the user and determine that, for this type of predictive anomaly, the event data is to be transmitted to a caregiver, automated system, or hybrid mechanism associated with the user. The caregiver may use this data to further evaluate the user to determine the cause of the predictive anomaly. By performing event data routing determinations according to the category of the identified event (e.g., type of predictive anomaly, absence of a predictive anomaly, etc.), the event data transmission module 108 may improve the functioning of the user monitoring gateway 102 by reducing the volume of event data transmissions to different entities to which corresponding event data may not be relevant or that otherwise may be unable to address a corresponding detected predictive anomaly.

In an embodiment, if the event data corresponds to a predictive anomaly, the event data transmission module 108 further transmits an anomaly notification to a root-cause analysis system 110, which may evaluate the event data corresponding to the predictive anomaly to identify a root cause of the predictive anomaly. As illustrated in FIG. 1, the root-cause analysis system 110 may be implemented as a standalone system that is distinct from the user monitoring gateway 102. For instance, the root-cause analysis system 110 may be implemented by a remote user monitoring service, which may provide user monitoring gateways to different users to monitor the health of these users and to perform the various functionalities described herein. The root-cause analysis system 110, in some instances, may receive requests from different entities associated with the user to identify a root-cause of a particular predictive anomaly or other event. For example, if medical personnel have been deployed to treat a user in response to a particular medical emergency, the medical personnel may transmit a request to the root-cause analysis system 110 to determine a potential root-cause for the particular medical emergency. As another illustrative example, a caregiver associated with the user, in response to detecting that the user's blood pressure has decreased over time without any apparent explanation, may transmit a request to the root-cause analysis system 110 to identify a potential root-cause for this decrease in the user's blood pressure. Requests to the root-cause analysis system 110 may be submitted through an application or web portal associated with the user monitoring gateway 102 and/or the remote user monitoring service. In an embodiment, the root-cause analysis system 110 may automatically process event data corresponding to an identified predictive anomaly to dynamically identify a potential root-cause of the identified predictive anomaly without need for an external request from another entity. This may reduce the amount of time required to address the identified predictive anomaly, as the other entity may immediately obtain the root-cause of the predictive anomaly upon accessing the root-cause analysis system 110 rather than having to wait for the root-cause analysis system 110 to process the event data in response to a request submission by the entity.

In an embodiment, the root-cause analysis system 110, in response to a notification corresponding to a predictive anomaly (e.g., a request from an external entity, a predictive anomaly notification from the event data transmission module 108, etc.), the root-cause analysis system 110 queries the user monitoring system 104 of the user monitoring gateway 102 to obtain any available historical event data associated with the user and the user environment (including any equipment or sensors associated with the user, ambient data corresponding to environmental events (e.g., meteorological events and disasters, allergen counts, localized disasters, environmental disasters, etc.) that may be processed to determine the root-cause of the predictive anomaly. The query from the root-cause analysis system 110, in some instances, may include an identifier corresponding to the user associated with the predictive anomaly. Additionally, or alternatively, the query from the root-cause analysis system 110 may include the one or more types of data that may be required to determine the root-cause of the predictive anomaly. For example, if the predictive anomaly corresponds to a user's lack of responsiveness, the root-cause analysis system 110 may query the user monitoring system 104 for any ambient data corresponding to the user's blood pressure and glucose levels over a period of time. As another illustrative example, if the predictive anomaly corresponds to a drop in the user's blood oxygen levels, the root-cause analysis system 110 may query the user monitoring system 104 to obtain any ambient data corresponding to smoke detectors deployed in the user environment, temperature sensors deployed in the user environment, activities performed by the user in the user environment, external data sources relevant to the user environment (e.g., local and/or national meteorological data sources, Building Information Management (BIM) systems associated with the user environment, etc.) and the like.

To determine what data may be required to identify a possible root-cause for a predictive anomaly, the root-cause analysis system 110 may implement a machine learning algorithm or artificial intelligence that is dynamically trained to process data corresponding to the predictive anomaly (as provided in the predictive anomaly notification or from another entity) to identify the types of data that may be analyzed to determine a root-cause for the predictive anomaly. This machine learning algorithm or artificial intelligence may be trained using supervised, unsupervised, or hybrid training techniques. For instance, a dataset of sample event data (e.g., historical event data, hypothetical or artificial event data, combinations of historical and hypothetical event data, etc.), sample event classifications (i.e., event types, categories, etc.), and sample ambient data corresponding to the sample event classifications (e.g., ambient data types, categories, etc.) may be analyzed using a clustering or classification algorithm to classify the sample event data according to the different sample event classifications to identify what sample ambient data may be required to determine the root-cause of the corresponding sample events. The machine learning algorithm or artificial intelligence may be dynamically trained in real-time by converting the sample event data into a set of embeddings and the set of sample event classifications into a set of event classification embeddings. In some instances, the machine learning algorithm or artificial intelligence may be implemented with a threshold that may be used to determine, based on the aforementioned embeddings and different vectors of similarity, whether sample event data is sufficiently similar (e.g., satisfies the threshold by having a requisite amount of embeddings being within a level of tolerance of corresponding event classification embeddings for a particular event classification) to a particular sample event classification.

Through the machine learning algorithm or artificial intelligence, the root-cause analysis system 110 may perform such clustering or classification of event data from the event data transmission module 108 to identify the type or category of event detected and, accordingly, identify what data may be required from the user monitoring gateway 102 to determine the root-cause of the detected event and corresponding predictive anomaly. In an embodiment, the root-cause analysis system 110, based on the identified type or category of the event and predictive anomaly detected, transmits a request to the user monitoring system 104 of the user monitoring gateway 102 to retrieve any historical ambient data corresponding to the identified type or category of the event and that may be processed to determine the root-cause of the predictive anomaly. The request may specify the type or category of ambient data that is to be retrieved, as well as a time range for which ambient data is to be provided. This time range may correspond to the times at which the requested ambient data was generated by the devices and sensors 112 within the user environment. In response to the request, the user monitoring system 104 may query the data storage repository 106 to retrieve the requested ambient data. Accordingly, the user monitoring system 104, in response to the request from the root-cause analysis system 110, may transmit the requested ambient data to the root-cause analysis system 110.

In an embodiment, the root-cause analysis system 110 implements a root-cause determination machine learning algorithm that is dynamically trained to determine the one or more root-causes of a detected predictive anomaly. The root-cause determination machine learning algorithm may be dynamically trained using supervised, unsupervised, or hybrid training techniques. For instance, a dataset of sample ambient data (e.g., known or historical ambient data, hypothetical or artificial ambient data, combinations of known/historical and hypothetical/artificial ambient data, etc.), sample event data (e.g., known or historical event data, hypothetical or artificial event data, combinations of known/historical and hypothetical/artificial event data, etc.), and sample root-causes corresponding to the sample ambient data and event data may be generated for training of the root-cause determination machine learning algorithm. The sample ambient data for each corresponding sample event and root-cause may include a time series of ambient data over a particular period of time. For instance, a sample time series of ambient data may be defined to allow for processing with corresponding event data to determine a root-cause for a detected event.

In an embodiment, to dynamically train the root-cause determination machine learning algorithm, the root-cause analysis system 110 generates an initial iteration of the root-cause determination machine learning algorithm. For instance, the root-cause analysis system 110 may initialize a set of coefficients randomly through Gaussian or non-Gaussian distributions. Using this initial iteration of the root-cause determination machine learning algorithm, the root-cause analysis system 110 may process the aforementioned dataset to generate an output (e.g., predicted root-causes for each subset of ambient data and corresponding event data, etc.). The root-cause analysis system 110 may compare the generated output to the sample root-causes defined in the dataset to identify any inaccuracies or other errors.

If the output of the root-cause determination machine learning algorithm does not satisfy one or more criteria (e.g., a root-cause accuracy threshold, etc.), the root-cause analysis system 110 may update one or more coefficients of the set of coefficients to generate a new iteration of the root-cause determination machine learning algorithm. This new iteration of the root-cause determination machine learning algorithm may be used to process the aforementioned dataset, as well as any additional data points or other datasets obtained by the root-cause analysis system 110 to generate a new output (e.g., new predicted root-causes) for each data point in the dataset. The root-cause analysis system 110 may again evaluate this new output against the sample root-causes defined in the dataset to identify any new or remaining inaccuracies or other errors. This process of updating the set of coefficients associated with the root-cause determination machine learning algorithm according to the one or more criteria may be performed iteratively until an iteration of the root-cause determination machine learning algorithm is generated that satisfies the one or more criteria.

In an embodiment, the root-cause analysis system 110 processes the event data from the event data transmission module 108 and historical ambient data from the user monitoring system 104 through the root-cause determination machine learning algorithm to determine one or more root-causes for the predictive anomaly. As an illustrative example, in response to a predictive anomaly corresponding a user's blood pressure being below a threshold value, the root-cause analysis system 110, through the root-cause determination machine learning algorithm, may determine that over a period, the user's blood pressure has been trending downward. Additionally, the root-cause determination machine learning algorithm, through evaluation of corresponding ambient data, may determine that the user has spent less time eating and that their liquid intake over the same period of time has decreased. Accordingly, the root-cause analysis system 110, through the root-cause determination machine learning algorithm, may determine that the root-cause of the user's blood pressure issues is related to user dehydration and lack of nutrition over a period of time.

In an embodiment, the root-cause analysis system 110, through the root-cause determination machine learning algorithm, generates different confidence scores for different possible root-causes of the detected predictive anomaly. A confidence score for a particular root-cause may represent the likelihood of the particular root-cause being responsible for the detected predictive anomaly. For instance, a higher confidence score for a particular root-cause may denote that the particular root-cause is more likely to have been responsible for the detected predictive anomaly. Alternatively, a lower confidence score for a particular root-cause may denote that the particular root-cause is less likely to have been responsible for the detected predictive anomaly. In some instances, the root-cause analysis system 110 may implement one or more criteria for identifying one or more probable root-causes for the detected predictive anomaly. For example, the one or more criteria may include a confidence score threshold whereby any root-causes having a confidence score below this confidence score threshold are automatically discarded as not being probable root-causes of the predictive anomaly. If no possible root-causes are assigned confidence scores above this confidence score threshold, the root-cause analysis system 110 may transmit one or more notifications to one or more notification recipients 114 indicating that a root-cause could not be determined for the predictive anomaly. This may cause the one or more notification recipients 114 to perform manual analysis of the event data corresponding to the predictive anomaly to identify a root-cause. If a root-cause is determined through this manual analysis, the root-cause analysis system 110 may re-train the root-cause determination machine learning algorithm to improve the likelihood of the root-cause determination machine learning algorithm assigning a higher confidence score for this identified root-cause for similar predictive anomalies.

Once the root-cause analysis system 110 has identified one or more probable root-causes for the detected predictive anomaly, the root-cause analysis system 110 may transmit one or more root-cause notifications to one or more notification recipients 114. The one or more root-cause notifications may specify the one or more probable root-causes for the detected predictive anomaly, as well as the confidence scores corresponding to these one or more probable root-causes and the ambient and event data corresponding to the predictive anomaly and used to identify the one or more probably root-causes. In an embodiment, the one or more notification recipients 114 are identified according to any applicable user preferences associated with the user. These user preferences may be categorized according to the type of predictive anomaly detected. For example, if the predictive anomaly corresponds to a medical emergency, the root-cause analysis system 110 may transmit the one or more root-cause notifications to medical personnel that may be able to address the medical emergency. As another illustrative example, if the predictive anomaly corresponds to a user's lack of appetite, the root-cause analysis system 110 may transmit the one or more root-cause notifications to a caregiver that may use the corresponding data to address any issues related to the user's eating habits. Thus, the event data corresponding to the predictive anomaly and the one or more probable root causes (including corresponding scores) may be transmitted to different notification recipients 114 according to the abilities of the different notification recipients 114 in addressing the category or type of predictive anomaly identified by the event data transmission module 108.

In an embodiment, the root-cause analysis system 110 can further evaluate subsequent ambient and event data from the user monitoring gateway 102 to determine whether a predictive anomaly associated with a user has been resolved. For instance, once the root-cause analysis system 110 has transmitted the one or more root-cause notifications to one or more notification recipients 114, the root-cause analysis system 110 may continue to query the user monitoring system 104 for new ambient and event data that may be evaluated to determine whether the predictive anomaly has been resolved or is ongoing. In some instances, the root-cause analysis system 110 may transmit a request to the user monitoring system 104 to dynamically process new ambient data from the one or more devices and sensors 112 and return any event data corresponding to the predictive anomaly for which the root-cause analysis system 110 identified one or more root-causes if the user monitoring system 104 still detects this predictive anomaly. If the predictive anomaly is still ongoing, the root-cause analysis system 110 may continue to transmit root-cause notifications to the one or more notification recipients 114, indicating that the predictive anomaly has not been resolved. Alternatively, if the predictive anomaly is no longer detected, the one or more root-causes associated with the predictive anomaly may be deemed resolved.

In an embodiment, if the root-cause analysis system 110 determines that a predictive anomaly has been resolved, the root-cause analysis system 110 transmits a notification to the user monitoring system 104 and to the event data transmission module 108 to indicate that the predictive anomaly has been resolved. This may cause the user monitoring system 104 to archive the data corresponding to the predictive anomaly and monitor new real-time ambient data from the myriad devices and sensors 112 to detect any new predictive anomalies within the user environment. Alternatively, if the predictive anomaly is not resolved, the root-cause analysis system 110 may continue to process new event data corresponding to the predictive anomaly to identify any probable root-causes and determine whether these probable root-causes are similar to those previously identified for the predictive anomaly or are new. If the probable root-causes are new, the root-cause analysis system 110 may transmit root-cause notifications corresponding to these new probable root causes to one or more notification recipients 114 according to the type or category of the predictive anomaly and of the new probable root causes.

In an embodiment, the root-cause analysis system 110 evaluates any obtained event data to determine whether the event data is identical to previously received event data corresponding to a predictive anomaly. For instance, when the root-cause analysis system 110 receives event data corresponding to a predictive anomaly in order to determine the one or more root-causes of the predictive anomaly, the root-cause analysis system 110 may process the event data through a hash function to generate a hash of the event data, excluding any timestamps or other temporal indicators that may deterministically alter the resulting hash. In an embodiment, the root-cause analysis system 110 maintains a cache of event hashes that stores event hashes previously generated over a pre-defined period of time (e.g., one hour, two hours, etc.). As the root-cause analysis system 110 receives event data from the event data transmission module 108, the root-cause analysis system 110 may hash this event data, excluding any timestamps or other temporal indicators, and compare the resulting event data hash to the event hashes stored in the cache to determine whether the received event data is a duplicate of previously obtained event data. If the root-cause analysis system 110 determines that the hash of the received event data matches a hash maintained in the cache, the root-cause analysis system 110 may determine that the received event data is duplicative and, thus, may not need to be processed to determine the root-causes of the predictive anomaly. Further, in some instances, the root-cause analysis system 110 may remove the previously recorded hash from the cache and replace this previously recorded hash with the new event data hash. This may serve as an indication that the predictive anomaly is still ongoing as of the time indicated in a timestamp associated with the new event data. Alternatively, in some instances, the root-cause analysis system 110 may retain the previously recorded hash in the cache (along with a timestamp corresponding to when the event data was generated), which may serve as an indication that the detected predictive anomaly is ongoing at least from the time indicated in the timestamp.

In an embodiment, for each predictive anomaly, the root-cause analysis system 110 maintains a predictive anomaly record within which the root-cause analysis system 110 may record any obtained event data corresponding to this predictive anomaly. Further, the root-cause analysis system 110 may process this predictive anomaly record through a hash function to generate a predictive anomaly hash. In an embodiment, the root-cause analysis system 110 compares this predictive anomaly hash to other predictive anomaly hashes maintained in a cache to determine whether the predictive anomaly is like a previously detected predictive anomaly for which one or more root-causes may have been previously determined. If the root-cause analysis system 110 determines that predictive anomaly is like a previously detected predictive anomaly, the root-cause analysis system 110 may perform any of the aforementioned operations corresponding to the detection duplicative event data. In an embodiment, once the root-cause analysis system 110 determines that a particular predictive anomaly has been resolved, the root-cause analysis system 110 may clear the cache of any hashes corresponding to the predictive anomaly. This may allow for the detection of new instances of the predictive anomaly should this predictive anomaly occur at a later time.

In an embodiment, the root-cause analysis system 110 retrains or otherwise updates the root-cause determination machine learning algorithm according to feedback obtained from one or more notification recipients 114 about different root-causes provided for detected predictive anomalies. For instance, if the root-cause analysis system 110 indicates that a user's drop in blood pressure was due to a prolonged period of malnutrition (e.g., reduced eating habits, reduced liquid intake, etc.), but the actual root-cause (as identified by medical personnel, for example) was an internal injury resulting from a fall within the user environment, the root-cause analysis system 110 may use this information to update the dataset used to train the root-cause determination machine learning algorithm such that, for similar predictive anomalies (e.g., drops in blood pressure, etc.), the root-cause determination machine learning algorithm may be more likely to identify a fall and internal injury as possible root-causes.

If the root-cause determination machine learning algorithm fails to detect a particular root-cause for a predictive anomaly associated with the user, the root-cause analysis system 110 may update the dataset used to train the root-cause determination machine learning algorithm to add a data point that indicates, for the particular predictive anomaly, the one or more root-causes that should have been identified. The updated training dataset may be used to evaluate the performance of the root-cause determination machine learning algorithm and, accordingly, generate a new iteration of the root-cause determination machine learning algorithm that more accurately identifies root-causes for detected predictive anomalies. This iterative process may continue until an iteration of the root-cause determination machine learning algorithm is generated that satisfies the one or more criteria. Thus, as different predictive anomalies are processed in real-time or near real-time to determine the underlying root-causes of these predictive anomalies, the root-cause determination machine learning algorithm is continuously updated to better identify the probable root-causes for these different predictive anomalies. Further, this iterative process of re-training or otherwise updating the root-cause determination machine learning algorithm may be performed according to the predictive anomalies and corresponding root-causes associated with an individual, a group of individuals (e.g., such as in a multi-user environment), and/or a class of individuals (based on demographics or other criteria).

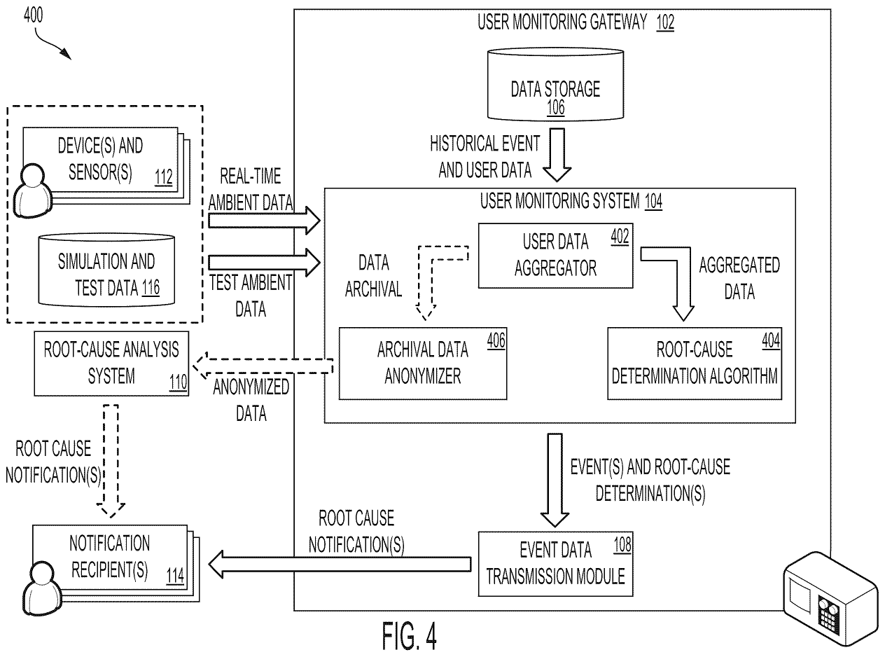

It should be noted that while the root-cause analysis system 110 is illustrated in FIG. 1 as being a separate and distinct system from the user monitoring gateway 102, the functionality of the root-cause analysis system 110 may be implemented by the user monitoring gateway 102. For example, and as illustrated in FIG. 4, the user monitoring system 104 may implement and dynamically train the root-cause determination algorithm to dynamically generate root-cause determinations for detected predictive anomalies. These root-cause determinations and corresponding event data may be provided to the event data transmission module 108, which, in turn, may transmit the root-cause determinations and corresponding event data to the appropriate notification recipients 114. In such instances, if the user monitoring gateway 102 may anonymize any ambient and event data corresponding to a user and transmit the anonymized data to the root-cause analysis system 110 for long-term storage. This anonymization and long-term storage of ambient and event data corresponding to the user may be performed subject to user consent. In some instances, the functionality of the root-cause analysis system 110 may be implemented through one or more intermediate gateway devices within the user environment and/or other environments.

In some instances, the functionality of the root-cause analysis system 110 may be implemented through any combination of the user monitoring gateway 102, the one or more intermediate gateway devices, and the remote user monitoring service described above. The configuration of these devices and services may dynamically change based on different factors. For example, when a user departs from the user environment where the user monitoring gateway 102 is implemented, the user may activate a mobile user monitoring device that may store ambient data from devices and sensors that may be in proximity to the mobile user monitoring device. In some instances, this mobile user monitoring device may implement some or all of the functionality of the root-cause analysis system 110, whereby the mobile user monitoring device may automatically process obtained ambient data, detect predictive anomalies based on this ambient data (such as through internal processes and/or through transmission of the ambient data to the remote user monitoring service), and determine the root-causes of the predictive anomaly as required. When the user returns to the user environment where the user monitoring gateway 102 is implemented, this mobile user monitoring device may automatically transmit any collected and generated data to the user monitoring gateway 102 to avoid any data gaps.

In an embodiment, the user monitoring gateway 102 and the root-cause analysis system 110, through the aforementioned components and corresponding machine learning algorithms or artificial intelligence, can continuously and simultaneously process ambient data from the myriad devices and sensors within the user environment to detect, in real-time or near real-time, any events occurring within a user environment, identify any predictive anomalies corresponding to these events, and identify the root-causes of these predictive anomalies. For instance, as different ambient data associated with different devices and/or sensors within different portions of the user environment is obtained, the user monitoring gateway 102, through the aforementioned components and corresponding machine learning algorithms or artificial intelligence, may simultaneously process this ambient data from these different devices and/or sensors to detect any number of simultaneously occurring events within the user environment, classify the data corresponding to these events, and evaluate the data corresponding to these simultaneously occurring events to identify any predictive anomalies occurring within the user environment. Additionally, as the predictive anomalies are identified, the root-cause analysis system 110, through the root-cause determination machine learning algorithm, may simultaneously process historical and present data corresponding to a user and for these different predictive anomalies to determine the root-causes of these different predictive anomalies.

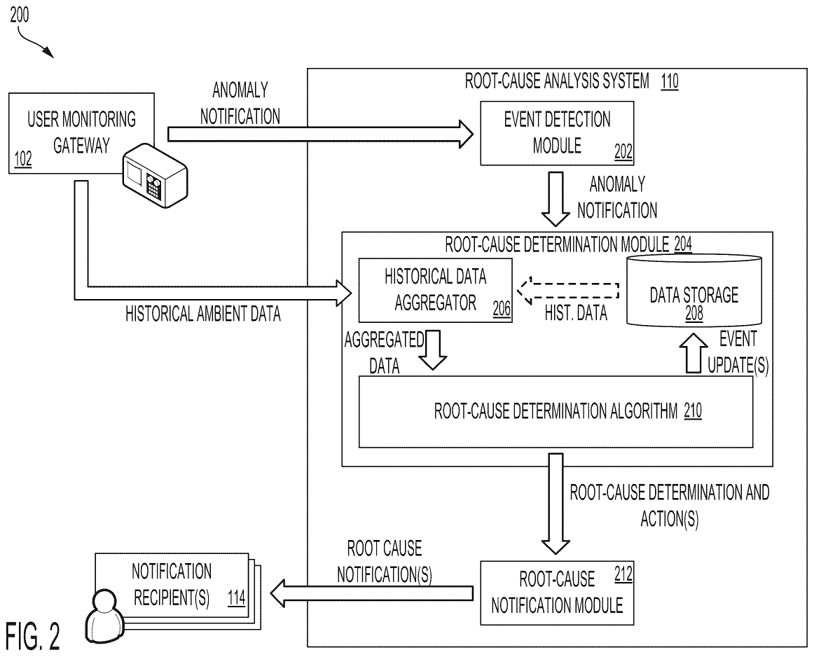

FIG. 2 shows an illustrative example of an environment 200 in which a root-cause determination module 204 of a root-cause analysis system 110 dynamically processes event data corresponding to a user predictive anomaly and historical data corresponding to the user to identify one or more root-causes of the user predictive anomaly in accordance with at least one embodiment. In the environment 200, the root-cause analysis system 110 implements an event detection module 202 configured to obtain real-time predictive anomaly notifications from the user monitoring gateway 102 as predictive anomalies are detected by the user monitoring gateway 102. The event detection module 202 may comprise one or more computer systems of the root-cause analysis system 110 or may be implemented as an application or process executing on a computer system of the root-cause analysis system 110. In some instances, the event detection module 202 may be configured with various special-purpose components that can facilitate real-time or near real-time processing of predictive anomaly notifications as the predictive anomaly notifications are received. The event detection module 202 may continuously, in real-time or near real-time, evaluate received predictive anomaly notifications from the user monitoring gateway 102 to determine whether predictive anomaly notifications include the requisite data corresponding to a detected predictive anomaly. For instance, the event detection module 202 may evaluate a newly received predictive anomaly notification to determine whether the predictive anomaly notification includes event data corresponding to the predictive anomaly. If the predictive anomaly notification does not include the requisite event data corresponding to an indicated predictive anomaly, the event detection module 202 may transmit a request to the user monitoring gateway 102 to retrieve the event data corresponding to the predictive anomaly. The event detection module 202, in response to receiving the requisite event data, may update the received predictive anomaly notification to incorporate the event data from the user monitoring gateway 102.

It should be noted that while FIG. 2 provides an illustrative example of the event detection module 202 receiving predictive anomaly notifications from the user monitoring gateway 102, the event detection module 202 may receive predictive anomaly notifications from other entities. Returning to an earlier illustrative example, if medical personnel have been deployed to treat a user in response to a particular medical emergency, the medical personnel may transmit a request to the root-cause analysis system 110 to determine a potential root-cause for the particular medical emergency. As another illustrative example, a caregiver associated with the user, in response to detecting that the user's blood pressure has decreased over time without any apparent explanation, may transmit a request to the root-cause analysis system 110 to identify a potential root-cause for this decrease in the user's blood pressure. Requests to the root-cause analysis system 110 may be submitted through an application or web portal associated with the user monitoring gateway 102 and/or a remote user monitoring service. Further, these requests may be processed by the event detection module 202, which may obtain any available event data corresponding to the predictive anomaly from the request and generate a predictive anomaly notification for further processing.

In an embodiment, as the event detection module 202 receives predictive anomaly notifications from the user monitoring gateway 102, the event detection module 202 transmits the predictive anomaly notifications to a root-cause determination module 204 for identification of one or more root-causes for the corresponding predictive anomaly. The root-cause determination module 204 may comprise one or more computer systems of the root-cause analysis system 110 or may be implemented as an application or process executing on a computer system of the root-cause analysis system 110. In some instances, the root-cause determination module 204 may be configured with various special-purpose components that can facilitate real-time or near real-time processing of predictive anomaly notifications to identify any root-causes associated with the predictive anomalies indicated in the received predictive anomaly notifications.

As illustrated in FIG. 2, the root-cause determination module 204 may include a historical data aggregator 206 that may obtain any available historical ambient data from the user monitoring gateway 102 that may be used to identify the one or more root-causes of a predictive anomaly indicated in the received predictive anomaly notification. In an embodiment, the root-cause determination module 204 implements a machine learning algorithm or artificial intelligence that is dynamically trained to process the event data corresponding to the predictive anomaly from the obtained notification to identify the types of ambient data that may be analyzed to determine the one or more root-causes for the predictive anomaly. The machine learning algorithm implemented by the historical data aggregator 206 may be trained using supervised, unsupervised, or hybrid training techniques. For instance, a dataset of sample event data (e.g., historical event data, hypothetical or artificial event data, combinations of historical and hypothetical event data, etc.), sample event classifications (i.e., event types, categories, etc.), and sample ambient data corresponding to the sample event classifications (e.g., ambient data types, categories, etc.) may be analyzed using a clustering or classification algorithm to classify the sample event data according to the different sample event classifications to identify what sample ambient data may be required to determine the root-cause of the corresponding sample events. The machine learning algorithm or artificial intelligence may be dynamically trained in real-time by converting the sample event data into a set of embeddings and the set of sample event classifications into a set of event classification embeddings. In some instances, the machine learning algorithm or artificial intelligence may be implemented with a threshold that may be used to determine, based on the aforementioned embeddings and different vectors of similarity, whether sample event data is sufficiently similar (e.g., satisfies the threshold by having a requisite amount of embeddings being within a level of tolerance of corresponding event classification embeddings for a particular event classification) to a particular sample event classification.

Through the machine learning algorithm or artificial intelligence, the historical data aggregator 206 may perform such clustering or classification of event data from the obtained predictive anomaly notification to identify the type or category of predictive anomaly detected and, accordingly, identify what ambient data may be required from the user monitoring gateway 102 to determine the root-cause of the predictive anomaly. In an embodiment, the historical data aggregator 206, based on the identified type or category of the predictive anomaly detected, transmits a request to the user monitoring gateway 102 to retrieve any historical ambient data corresponding to the identified type or category of the predictive anomaly and that may be processed to determine the root-cause of the predictive anomaly. The request may specify the type or category of ambient data that is to be retrieved, as well as a time range for which ambient data is to be provided. The user monitoring gateway 102, in response to the request from the historical data aggregator 206, may transmit the requested ambient data to the historical data aggregator 206.

In some instances, if the predictive anomaly indicated in the predictive anomaly notification was previously detected and has not been previously resolved, the historical data aggregator 206 may query a data storage repository 208 of the root-cause determination module 204 to automatically retrieve any historical data (e.g., historical ambient data, historical event data, etc.) associated with the predictive anomaly. This historical data may have been previously obtained from the user monitoring gateway 102 in response to a first instance of the predictive anomaly being detected. The historical data from the data storage repository 208 may be used in conjunction with any new event data corresponding to an ongoing predictive anomaly to identify any new root-causes for the predictive anomaly, revise any previously identified root-causes for the predictive anomaly, and/or to escalate notifications related to the predictive anomaly, as described in greater detail herein.

In an embodiment, the historical data aggregator 206 aggregates the event data from the predictive anomaly notification with historical ambient data obtained from the user monitoring gateway 102 and any other historical data from the data storage repository 208 (if the predictive anomaly was previously detected and is ongoing). The historical data aggregator 206 may use this aggregated data as input to a root-cause determination machine learning algorithm 210 to automatically identify one or more root-causes for the detected predictive anomaly. As noted above, the root-cause determination machine learning algorithm 210 is dynamically trained using a dataset of sample ambient data, sample event data, and sample root-causes corresponding to the sample ambient data and event data. The sample ambient data for each corresponding sample event and root-cause may include a time series of ambient data over a particular period of time. For instance, a sample time series of ambient data may be defined to allow for processing with corresponding event data to determine a root-cause for a detected event.

To implement the root-cause determination machine learning algorithm 210, the root-cause determination module 204 may generate an initial iteration of the root-cause determination machine learning algorithm. For instance, the root-cause determination module 204 may initialize a set of coefficients randomly through Gaussian or non-Gaussian distributions. Using this initial iteration of the root-cause determination machine learning algorithm 210, the root-cause determination module 204 may process the training dataset to generate an output (e.g., predicted root-causes for each subset of ambient data and corresponding event data, etc.). The root-cause determination module 204 may compare the generated output to the sample root-causes defined in the dataset to identify any inaccuracies or other errors. If the output of the root-cause determination machine learning algorithm 210 does not satisfy one or more criteria (e.g., a root-cause accuracy threshold, etc.), the root-cause determination module 204 may update one or more coefficients of the root-cause determination machine learning algorithm 210 to generate a new iteration of the root-cause determination machine learning algorithm 210. This new iteration of the root-cause determination machine learning algorithm 210 may be used to process the aforementioned dataset, as well as any additional data points or other datasets obtained by the root-cause analysis system 110 to generate a new output (e.g., new predicted root-causes) for each data point in the dataset. The root-cause determination module 204 may again evaluate this new output against the sample root-causes defined in the dataset to identify any new or remaining inaccuracies or other errors. This process of updating the set of coefficients associated with the root-cause determination machine learning algorithm 210 according to the one or more criteria may be performed iteratively until an iteration of the root-cause determination machine learning algorithm 210 is generated that satisfies the one or more criteria.

The root-cause determination machine learning algorithm 210 may dynamically process the aggregated data from the historical data aggregator 206 to determine one or more root-causes for the predictive anomaly. Returning to an earlier illustrative example, in response to a predictive anomaly corresponding a user's blood pressure being below a threshold value, the root-cause determination module 204, through the root-cause determination machine learning algorithm 210, may determine that over a period, the user's blood pressure has been trending downward. Additionally, the root-cause determination machine learning algorithm 210, through evaluation of corresponding ambient data, may determine that the user has spent less time eating and that their liquid intake over the same period of time has decreased. Accordingly, the root-cause determination machine learning algorithm 210 may identify the root-cause of the user's blood pressure issues as being related to user dehydration and lack of nutrition over a period of time.

Once the root-cause determination machine learning algorithm 210 has identified one or more root-causes for a particular predictive anomaly, the root-cause determination machine learning algorithm 210 may update the data storage repository 208 to record these one or more root-causes for the particular predictive anomaly. For instance, an entry corresponding to this predictive anomaly in the data storage repository 208 may be updated to incorporate the one or more root-causes for the predictive anomaly, as well as the aggregated data processed by the root-cause determination machine learning algorithm 210 to identify the one or more root-causes. As noted above, if a new notification corresponding to this predictive anomaly is received, the historical data aggregator 206 may obtain this aggregated data from the data storage repository 208 for further evaluation in conjunction with new ambient and event data corresponding to the predictive anomaly.

In an embodiment, the root-cause determination module 204 further evaluates newly obtained event data from the anomaly notification, as well as any historical data corresponding to the predictive anomaly to identify any rates of change to different values or metrics previously processed through the root-cause determination algorithm 210 to identify the root-cause of the predictive anomaly. These rates of change, in some instances, may denote the frequency in which the predictive anomaly is detected within the user environment, which may serve as an indication as to whether notification recipients 114 have taken the appropriate course of action to address the predictive anomaly. For example, based on an identified root-cause, the method utilized by a notification recipient 114 to address the root-cause (e.g., a medical treatment, an intervening act, adjustments to one or more sensors within the user environment, etc.), and subsequent event data corresponding to the predictive anomaly, the root-cause determination module 204 may determine whether the frequency in which the predictive anomaly is detected has increased, decreased, or remained static. If the frequency remains unchanged or increases, this may denote that the actions taken to address the predictive anomaly are ineffective, which in turn may denote that the identified root-cause for the predictive anomaly may be incorrect. Alternatively, if the frequency decreases, this may denote that the actions taken to address the predictive anomaly are likely effective in addressing the predictive anomaly and, thus, the correct root-cause was identified for the predictive anomaly. This frequency data, thus, may be used to re-train or otherwise update the root-cause determination algorithm 210 to improve the detection of root-causes to different predictive anomalies. Further, as described in greater detail herein, any notification recipients 114 to which root-cause notifications are provided for a detected predictive anomaly may be further notified with regard to the effectiveness of actions performed to address the detected predictive anomaly.

In an embodiment, the root-cause determination machine learning algorithm 210 transmits the identified root-causes, the corresponding aggregated data associated with the predictive anomaly, and any recommended actions for addressing the identified root-causes and the predictive anomaly to a root-cause notification module 212. The root-cause notification module 212 may comprise one or more computer systems of the root-cause analysis system 110 or may be implemented as an application or process executing on a computer system of the root-cause analysis system 110. In some instances, the root-cause notification module 212 may be configured with various special-purpose components that can facilitate real-time or near real-time processing of identified root-causes for different predictive anomalies, corresponding aggregated data, and recommended actions to generate notifications that may be provided to different notification recipients 114 according to any user preferences and/or predictive anomaly categories.

The root-cause notification module 212, in response to receiving the identified root-causes, the corresponding aggregated data associated with the predictive anomaly, and any recommended actions for addressing the identified root-causes, may generate one or more root-cause notifications. These one or more root-cause notifications may specify the one or more probable root-causes for the detected predictive anomaly, as well as the ambient and event data corresponding to the predictive anomaly and used to identify the one or more probably root-causes. The root-cause notification module 212, in some instances, may identify the one or more notification recipients 114 for the root-cause notifications according to any applicable user preferences associated with the user. These user preferences may be categorized according to the type of predictive anomaly detected. For example, if the predictive anomaly corresponds to a medical emergency, the root-cause notification module 212 may transmit the one or more root-cause notifications to medical personnel that may be able to address the medical emergency. As another illustrative example, if the predictive anomaly corresponds to a user's lack of appetite, the root-cause notification module 212 may transmit the one or more root-cause notifications to a caregiver that may use the corresponding data to address any issues related to the user's eating habits.

As noted above, the root-cause determination module 204, through the historical data aggregator 206, may receive a predictive anomaly notification corresponding to a predictive anomaly that was previously detected by the user monitoring gateway 102 and that has not been resolved. For instance, after the root-cause analysis system 110 has identified one or more possible root-causes for a particular predictive anomaly, the predictive anomaly may remain unresolved due to various factors. For instance, if the root-cause determination machine learning algorithm 210 has failed to identify the correct one or more root-causes for the predictive anomaly, recipients of the root-cause notifications may be unable to address the predictive anomaly as they may be attempting to address the incorrect root-causes of the predictive anomaly. As another illustrative example, the predictive anomaly may remain unresolved as a result of the notification recipients 114 being unable to perform the requisite actions for addressing the identified root-causes of the predictive anomaly. In an embodiment, the root-cause determination module 204 can evaluate subsequent ambient and event data from the user monitoring gateway 102 to determine whether a predictive anomaly associated with a user has been resolved. For instance, once the root-cause notification module 212 has transmitted the one or more root-cause notifications to one or more notification recipients 114, the root-cause determination module 204, through the historical data aggregator 206, may continue to query the user monitoring gateway 102 for new ambient and event data that may be evaluated through the root-cause determination machine learning algorithm 210 to determine whether the predictive anomaly has been resolved or is ongoing. In some instances, the root-cause determination module 204 may transmit a request to the user monitoring gateway 102 to dynamically process new ambient data and return any event data corresponding to the predictive anomaly if this predictive anomaly is still ongoing. The root-cause analysis system 110, through the root-cause notification module 212, may continue to transmit root-cause notifications to the one or more notification recipients 114, indicating that the predictive anomaly has not been resolved. Alternatively, if the predictive anomaly is no longer detected, the one or more root-causes associated with the predictive anomaly may be deemed resolved.

According to the resolution of a predictive anomaly and any corresponding feedback, the root-cause determination module 204 may dynamically re-train or otherwise update the root-cause determination machine learning algorithm 210 to better diagnose the root-causes of different predictive anomalies and recommend different actions that may be performed to address these root-causes. For example, if the root-cause determination machine learning algorithm 210 indicates that a user's drop in blood pressure was due to a prolonged period of malnutrition (e.g., reduced eating habits, reduced liquid intake, etc.), but the actual root-cause (as identified by medical personnel, for example) was an internal injury resulting from a fall within the user environment, the root-cause determination module 204 may use this feedback to update the dataset used to train the root-cause determination machine learning algorithm 210 such that, for similar predictive anomalies (e.g., drops in blood pressure, etc.), the root-cause determination machine learning algorithm 210 may be more likely to identify a fall and internal injury as possible root-causes. Thus, if the root-cause determination machine learning algorithm 210 fails to detect a particular root-cause for a predictive anomaly associated with a user, the root-cause determination module 204 may update the dataset used to train the root-cause determination machine learning algorithm 210 to add a data point that indicates, for the particular predictive anomaly, the one or more root-causes that should have been identified. The updated training dataset may be used to evaluate the performance of the root-cause determination machine learning algorithm 210 and, accordingly, generate a new iteration of the root-cause determination machine learning algorithm 210 that more accurately identifies root-causes for detected predictive anomalies. This iterative process may continue until an iteration of the root-cause determination machine learning algorithm 210 is generated that satisfies the one or more criteria. Thus, as different predictive anomalies are processed in real-time or near real-time to determine the underlying root-causes of these predictive anomalies, the root-cause determination machine learning algorithm 210 is continuously updated to better identify the probable root-causes for these different predictive anomalies.

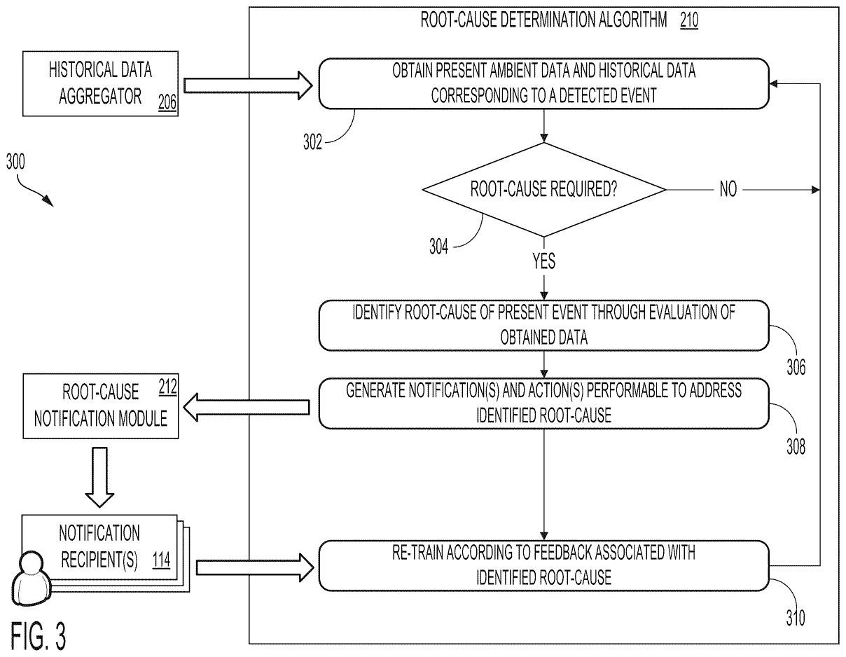

FIG. 3 shows an illustrative example of an environment 300 in which a root-cause determination machine learning algorithm 210 dynamically processes event data corresponding to a detected user anomaly and historical data corresponding to the user to identify a root-cause of the user predictive anomaly and transmit notifications corresponding to the identified root-cause to different recipients in accordance with at least one embodiment. In the environment 300, the root-cause determination machine learning algorithm 210, at step 302, may obtain present ambient data and historical data corresponding to a detected event. This data may be obtained through a historical data aggregator 206 and a data storage repository maintained by the aforementioned root-cause determination module. As noted above, the historical data aggregator 206 may obtain predictive anomaly notifications from an event detection module and corresponding to predictive anomalies and other events detected within the user environment. Further, the historical data aggregator 206 may query a data storage repository 208 of the root-cause determination module 204 to automatically retrieve any historical data (e.g., historical ambient data, historical event data, etc.) associated with the predictive anomaly (i.e., the predictive anomaly was previously detected and one or more root-causes were previously determined for the predictive anomaly).

As noted above, in some instances, the historical data aggregator 206 may implement and dynamically train a machine learning algorithm or artificial intelligence to process the event data corresponding to the predictive anomaly from the obtained notification to identify the types of ambient data that may be analyzed to determine the one or more root-causes for the predictive anomaly. Further, through the machine learning algorithm or artificial intelligence, the historical data aggregator 206 may classify the detected predictive anomaly as corresponding to a particular type or category. In an embodiment, certain types or categories of predictive anomalies do not require a root-cause analysis. For example, predictive anomalies associated with spontaneous events for which no historical data is available (e.g., major power outages, natural disasters, etc.) may not require root-cause analysis. As another illustrative example, predictive anomalies that are not associated with a user within the user environment (e.g., predictive anomalies associated with the functionality of devices and/or sensors that are not user-specific) may not require root-cause analysis. Thus, based on the particular type or category of the predictive anomaly (as determined by the historical data aggregator 206), the root-cause determination machine learning algorithm 210, at step 304, may determine whether a root-cause analysis is required. If a root-cause analysis is not required, the root-cause determination machine learning algorithm 210 may continue to process any new data supplied by the historical data aggregator 206.

If the root-cause determination machine learning algorithm 210 determines that a root-cause for the detected predictive anomaly is required, the root-cause determination machine learning algorithm 210, at step 306, may process the obtained data corresponding to the predictive anomaly to identify one or more root-causes for the predictive anomaly. As noted above, the root-cause determination machine learning algorithm 210 is dynamically trained using a dataset of sample ambient data, sample event data, and sample root-causes corresponding to the sample ambient data and event data. The sample ambient data for each corresponding sample event and root-cause may include a time series of ambient data over a particular period of time. For instance, a sample time series of ambient data may be defined to allow for processing with corresponding event data to determine a root-cause for a detected event. Thus, the root-cause determination machine learning algorithm 210 may process the ambient data and event data obtained from the historical data aggregator 206 to generate an output that indicates the one or more root-causes for the predictive anomaly.

Once the root-cause determination machine learning algorithm 210 has identified one or more root-causes for the predictive anomaly, the root-cause determination machine learning algorithm 210, at step 308, may generate one or more notifications and actions performable to address the identified one or more root-causes. In an embodiment, the root-cause determination machine learning algorithm 210 is further dynamically trained to identify possible actions that may be performed to address different root-causes associated with different predictive anomalies. For instance, the root-cause determination machine learning algorithm 210 may be further trained using a dataset of sample predictive anomalies (e.g., historical or actual predictive anomalies, hypothetical predictive anomalies, combinations of historical/actual and hypothetical predictive anomalies, etc.), sample root-causes associated with the sample predictive anomalies, and known actions performable to address the sample root-causes of the sample predictive anomalies. The training of the root-cause determination machine learning algorithm 210 to identify actions performable to address identified root-causes for predictive anomalies may be performed according to the iterative training process described above. The root-cause determination machine learning algorithm 210 may incorporate these identified actions into the notifications corresponding to the predictive anomaly and transmit these notifications to the root-cause notification module 212.

As noted above, the root-cause notification module 212 may identify the one or more notification recipients 114 for the root-cause notifications according to any applicable user preferences associated with the user. These user preferences may be categorized according to the type of predictive anomaly detected. Based on these user preferences, the root-cause notification module 212 may transmit the one or more root-cause notifications to corresponding notification recipients 114 that may be able to address the underlying root-causes of the predictive anomaly.

At step 310, the root-cause determination machine learning algorithm 210 is re-trained according to feedback associated with the identified root-causes of the predictive anomaly. Returning to an earlier illustrative example, if the root-cause determination machine learning algorithm 210 indicates that a user's drop in blood pressure was due to a prolonged period of malnutrition, but the actual root-cause was an internal injury resulting from a fall within the user environment, this feedback may be used to update the dataset used to train the root-cause determination machine learning algorithm 210 such that, for similar predictive anomalies (e.g., drops in blood pressure, etc.), the root-cause determination machine learning algorithm 210 may be more likely to identify a fall and internal injury as possible root-causes. Thus, if the root-cause determination machine learning algorithm 210 fails to detect a particular root-cause for a predictive anomaly associated with a user, the dataset used to train the root-cause determination machine learning algorithm 210 may be updated to add a data point that indicates, for the particular predictive anomaly, the one or more root-causes that should have been identified. The updated training dataset may be used to evaluate the performance of the root-cause determination machine learning algorithm 210 and, accordingly through negative reinforcement, generate a new iteration of the root-cause determination machine learning algorithm 210 that more accurately identifies root-causes for detected predictive anomalies. This iterative process may continue until an iteration of the root-cause determination machine learning algorithm 210 is generated that satisfies the one or more criteria.

FIG. 4 shows an illustrative example of an environment 400 in which a user monitoring system 104 implemented by a user monitoring gateway 102 automatically determines a root-cause for a detected user predictive anomaly in accordance with at least one embodiment. In the environment 400, the user monitoring system 104 of the user monitoring gateway 102 is configured to detect any predictive anomalies associated with different users within the user environment and, based on the data associated with these predictive anomalies, identify the root-causes for these predictive anomalies. Thus, in some instances, the user monitoring gateway 102, through the user monitoring system 104, may locally determine the root-causes of detected predictive anomalies without need to transmit the data corresponding to these predictive anomalies to the root-cause analysis system 110, as described above in FIGS. 2-3.

As noted above, the user monitoring system 104 may continuously, and in real-time or near real-time, obtain ambient data associated with the user environment from the various devices and sensors 112 implemented in the user environment. In an embodiment, the user monitoring system 104 implements a user data aggregator 402 that is configured to automatically, and dynamically, process the ambient data from these various devices and sensors 112 in real-time as the ambient data is received. The user data aggregator 402 may implement a set of libraries or other resources corresponding to different data formats utilized by different devices and sensors 112 compatible with the user monitoring gateway 102. For instance, the ambient data generated and transmitted by the myriad devices and sensors 112 within a user environment and connected to the user monitoring gateway 102 through different communications channels may be constructed using different data structures. The user data aggregator 402 may maintain a set of libraries or other resources that indicate these different data structures according to the types of devices and sensors from which the user monitoring gateway 102 may be connected to. Additionally, the user data aggregator 402 may implement a set of libraries or other resources for processing semi-structured and unstructured data from different devices and sensors 112 within the user environment. For instance, the user data aggregator 402 may implement computer vision or other machine learning algorithms that are dynamically trained to process audiovisual data from different devices and sensors 112 within the multi-tenant environment to automatically identify various characteristics associated with the audiovisual data. As another illustrative example, the user data aggregator 402 may receive telemetry data or other IoT output from the one or more devices and sensors 112 that is unstructured and may necessitate format-specific algorithms or other processes for evaluating the telemetry data or other IoT output.

The user data aggregator 402, in an embodiment, redundantly stores any obtained ambient data from the myriad devices and sensors 112 in the data storage repository 106. The ambient data may be stored in the data storage repository 106 in conjunction with corresponding timestamps that may denote the time at which the ambient data was generated by the different devices and sensors 112. In some instances, the data storage repository 106 may store ambient data from the myriad devices and sensors 112 for a limited period of time (e.g., one week, one month, one year, etc.) to prevent a data overflow within the user monitoring gateway 102. In an embodiment, the user data aggregator 402 can detect when the data storage repository 106 has reached a maximum storage amount threshold. In such instances, the user data aggregator 402 can transmit this archival data to an archival data anonymizer 406, which may anonymize the archival ambient data from the data storage repository 106 and provide this anonymized archival ambient data to the root-cause analysis system 110 for persistent storage and use. In some instances, the anonymized archival data may be processed by the root-cause analysis system 110 according to the processes described above in connection with FIGS. 2-3 to identify any root-causes associated with detected predictive anomalies and transmit root-cause notifications to different notification recipients 114.

In an embodiment, the user data aggregator 402 implements and dynamically trains a machine learning algorithm or artificial intelligence to detect any activities or other events associated with a user within the user environment. In some instances, the observed events may be routine for the user associated with the user monitoring gateway 102. Further, through the machine learning algorithm or artificial intelligence, the user data aggregator 402 may detect an event corresponding to a possible incident within the user environment that is not routine, such as an accident within the user environment. Further, through the aforementioned machine learning algorithm or artificial intelligence, the user data aggregator 402 may detect the absence of ambient data corresponding to different activities within the user environment. As an illustrative example, if ambient data corresponding to a particular room within the user environment is not representative of the presence of a user and/or of an activity occurring within the room, the user data aggregator 402 may generate synthetic data corresponding to the lack of activity within the room. This lack of activity, in some instances, may be indicative of a deviation from routine activities and movements within the user environment and, thus, may be indicative of an issue with the user within the user environment. In some instances, the lack of ambient data over a period of time may be representative of an issue related to one or more devices and/or sensors 112 (which may include the user monitoring gateway 102 itself) within the user environment. If the user monitoring gateway 102 detects an issue related to one or more devices and/or sensors 112 within the user environment or related to the user monitoring gateway 102 device itself, the user monitoring gateway 102 may automatically perform one or more actions to address the issue. For instance, the user monitoring gateway 102 may automatically transmit a notification to one or more notification recipients 114 indicating the detected issue. This may cause these one or more notification recipients 114 to perform one or more remedial actions to address the related issue (e.g., troubleshooting the one or more devices and/or sensors 112, notifying entities capable of repairing the one or more devices and/or sensors 112, etc.). In some instances, the user monitoring gateway 102 may automatically initiate a restart process in order to reset the user monitoring gateway 102 to address the detected issue. As another illustrative example, the user monitoring gateway 102 may automatically transmit executable instructions to the affected one or more devices and/or sensors 112 to cause these one or more devices and/or sensors 112 to initiate a restart process or otherwise perform different troubleshooting processes to address the detected issue.

The machine learning algorithm or artificial intelligence implemented by the user data aggregator 402 may be dynamically trained using supervised, unsupervised, or hybrid training techniques. For instance, a dataset of sample ambient data and sample events may be analyzed using a clustering or classification algorithm to classify the sample ambient data according to a set of different classifications (e.g., events). For instance, the machine learning algorithm or artificial intelligence may be dynamically trained in real-time by converting the sample ambient data into a set of embeddings and the sample events into a set of event embeddings. The machine learning algorithm or artificial intelligence may classify the sample ambient data according to one or more vectors of similarity between the set of embeddings and the set of event embeddings. In some instances, the machine learning algorithm or artificial intelligence may be implemented with a threshold that may be used to determine, based on the aforementioned embeddings and the one or more vectors of similarity, whether sample ambient data is sufficiently similar (e.g., satisfies the threshold by having a requisite amount of embeddings being within a level of tolerance of corresponding event embeddings for a particular known event) to a particular sample event. In an embodiment, through the machine learning algorithm or artificial intelligence, the user data aggregator 402 may perform such clustering or classification of ambient data from different devices and sensors 112 in the user environment in real-time or near real-time as the ambient data is received. Through this processing of the ambient data, the user data aggregator 402 may obtain partial matches among different known events to detect an event occurring within the user environment.

In an embodiment, the machine learning algorithm or artificial intelligence implemented by the user data aggregator 402 is further trained using simulated and/or test ambient data from a simulation and test data repository 116. As noted above, the simulated and/or test ambient data used to dynamically train or fine-tune the machine learning algorithm or artificial intelligence may include hypothetical or artificial ambient data corresponding to different devices and/or sensors that may be implemented in the user environment or that are otherwise compatible with the user monitoring gateway 102. In some instances, the simulated and/or test ambient data from the simulation and test data repository 116 may include raw sensor and device data from different devices and/or sensors implemented in different testing environments and that are implemented in these different testing environments to generate synthetic, simulated, and/or replay data. This simulated and/or test ambient data from the simulation and test data repository 116 may be used to enhance or supplement the dataset used to dynamically train and fine-tune the machine learning algorithm or artificial intelligence implemented by the user data aggregator 402.

In an embodiment, through the machine learning algorithm or artificial intelligence, the user data aggregator 402 further determines whether the identified event corresponds to a predictive anomaly associated with a user within the user environment. For instance, through the machine learning algorithm or artificial intelligence, the user data aggregator 402 may perform clustering or classification of the obtained ambient data corresponding to the detected predictive anomaly to identify the type or category of predictive anomaly and, accordingly, identify what additional ambient data may be required from the data storage repository 106 and/or the root-cause analysis system 110 to determine the root-cause of the predictive anomaly. In an embodiment, the user data aggregator 402, based on the identified type or category of the predictive anomaly detected, queries the data storage repository 106 and/or the root-cause analysis system 110 to retrieve any historical ambient data corresponding to the identified type or category of the predictive anomaly and that may be processed to determine the root-cause of the predictive anomaly. The query may specify the type or category of ambient data that is to be retrieved, as well as a time range for which ambient data is to be provided.

In some instances, if the predictive anomaly detected by the user data aggregator 402 was previously detected by the user monitoring system 104 and has not been resolved, the user data aggregator 402 may query the data storage repository 106 and/or the root-cause analysis system 110 to automatically retrieve any historical data (e.g., historical ambient data, historical event data, etc.) associated with the predictive anomaly. This historical data may have been previously obtained by the user monitoring gateway 102 and processed by the user data aggregator 402 to detect an event and corresponding predictive anomaly within the user environment. The historical data from the data storage repository 106 and/or the root-cause analysis system 110 may be used in conjunction with any new event data corresponding to an ongoing predictive anomaly to identify any new root-causes for the predictive anomaly, revise any previously identified root-causes for the predictive anomaly, and/or to escalate notifications related to the predictive anomaly, as described in greater detail herein.

In an embodiment, the user data aggregator 402 aggregates the event data corresponding to the detected predictive anomaly with historical ambient data obtained from the data storage repository 106 and/or the root-cause analysis system 110. The user data aggregator 402 may use this aggregated data as input to a root-cause determination machine learning algorithm 404 to automatically identify one or more root-causes for the detected predictive anomaly. Similar to the root-cause determination machine learning algorithm 210 described above in connection with FIGS. 2-3, the root-cause determination machine learning algorithm 404 is dynamically trained using a dataset of sample ambient data, sample event data, and sample root-causes corresponding to the sample ambient data and event data. The sample ambient data for each corresponding sample event and root-cause may include a time series of ambient data over a particular period of time.

Similar to the root-cause determination machine learning algorithm 210 described above in connection with FIGS. 2-3, the root-cause determination machine learning algorithm 404 implemented by the user monitoring system 104 of the user monitoring gateway 102 may be initialized by defining a set of coefficients randomly through Gaussian or non-Gaussian distributions. Using this initial iteration of the root-cause determination machine learning algorithm 404, the user monitoring system 104 may process the training dataset to generate an output (e.g., predicted root-causes for each subset of ambient data and corresponding event data, etc.). The user monitoring system 104 may compare the generated output to the sample root-causes defined in the dataset to identify any inaccuracies or other errors. If the output of the root-cause determination machine learning algorithm 404 does not satisfy one or more criteria (e.g., a root-cause accuracy threshold, etc.), the user monitoring system 104 may update one or more coefficients of the root-cause determination machine learning algorithm 404 to generate a new iteration of the root-cause determination machine learning algorithm 210. This new iteration of the root-cause determination machine learning algorithm 404 may be used to process the aforementioned dataset, as well as any additional data points or other datasets obtained by the user monitoring gateway 102 (such as through the user data aggregator 402) to generate a new output (e.g., new predicted root-causes) for each data point in the dataset. The user monitoring system 104 may again evaluate this new output against the sample root-causes defined in the dataset to identify any new or remaining inaccuracies or other errors. This process of updating the set of coefficients associated with the root-cause determination machine learning algorithm 404 according to the one or more criteria may be performed iteratively until an iteration of the root-cause determination machine learning algorithm 404 is generated that satisfies the one or more criteria.

The root-cause determination machine learning algorithm 404 may dynamically process the aggregated data from the user data aggregator 402 to determine one or more root-causes for the predictive anomaly. Once the root-cause determination machine learning algorithm 404 has identified one or more root-causes for a particular predictive anomaly, the root-cause determination machine learning algorithm 404 may update the data storage repository 106 to record these one or more root-causes for the particular predictive anomaly. Additionally, the root-cause determination machine learning algorithm 404 may provide the event data corresponding to the predictive anomaly and any identified root-causes to the event data transmission module 108. Based on the type or category of predictive anomaly, the event data transmission module 108 may determine how to route the corresponding event data and identified root-causes to other entities (e.g., notification recipients 114). For instance, the event data transmission module 108 may automatically identify the one or more notification recipients 114 for the root-cause notifications according to any applicable user preferences associated with the user. As noted above, these user preferences may be categorized according to the type of predictive anomaly detected. For example, if the predictive anomaly corresponds to a medical emergency, the event data transmission module 108 may transmit the one or more root-cause notifications to medical personnel that may be able to address the medical emergency. As another illustrative example, if the predictive anomaly corresponds to a user's lack of appetite, the event data transmission module 108 may transmit the one or more root-cause notifications to a caregiver that may use the corresponding data to address any issues related to the user's eating habits.

In some instances, if the predictive anomaly corresponds to an issue with one or more devices and/or sensors 112 within the user environment, and the one or more root-causes for the predictive anomaly correspond to a particular mode of failure associated with the one or more devices and/or sensors 112 (e.g., a software crash, a hardware failure, battery or other power-related issues, etc.), the event data transmission module 108 may automatically identify one or more notification recipients 114 that may be able to address the particular issue with the one or more devices and/or sensors 112. For example, if the identified root-cause for a predictive anomaly corresponding to a particular device or sensor is related to a software failure, the event data transmission module 108 may transmit a reboot command to the particular device or sensor to perform a soft reset of the device or sensor. Further, the event data transmission module 108 may transmit a notification to a caregiver and/or other personnel within the user environment that may monitor the device or sensor and perform simple functions to address this software failure (e.g., perform a manual reboot, install updated software onto the device or sensor, etc.). As another illustrative example, if the identified root-cause for a predictive anomaly corresponding to a particular device or sensor is the result of a hardware fault or other failure that is preventing normal function of the device or sensor, the event data transmission module 108 may transmit a notification to a technician that may be able to repair or replace the device or sensor. In some instances, the event data transmission module 108 may additionally transmit a notification to other entities that may monitor aggregated faults across myriad devices and/or sensors (such as a manufacturer of a device or sensor, etc.) indicating the detected issue. This may allow these other entities to identify the root-causes of the detected issue and address this detected issue across the myriad devices and/or sensors before the issue proliferates to other devices and/or sensors.

Similar to the process for re-training the root-cause determination machine learning algorithm 210 described above in connection with FIGS. 2-3, the root-cause determination machine learning algorithm 404 implemented by the user monitoring system 104 may be re-trained according to the resolution of a predictive anomaly and any corresponding feedback as provided by any notification recipients 114, the user, other entity. Based on this feedback, the user monitoring system 104 may update the dataset used to train the root-cause determination machine learning algorithm 404 to add data points that indicate, for previously identified predictive anomalies, the root-causes for these predictive anomalies that should have been identified. The updated training dataset may be used to evaluate the performance of the root-cause determination machine learning algorithm 404 and, accordingly, generate a new iteration of the root-cause determination machine learning algorithm 404 that more accurately identifies root-causes for detected predictive anomalies. This iterative process may continue until an iteration of the root-cause determination machine learning algorithm 404 is generated that satisfies the one or more criteria. Thus, as different predictive anomalies are processed in real-time or near real-time to determine the underlying root-causes of these predictive anomalies, the root-cause determination machine learning algorithm 404 is continuously updated to better identify the probable root-causes for these different predictive anomalies.

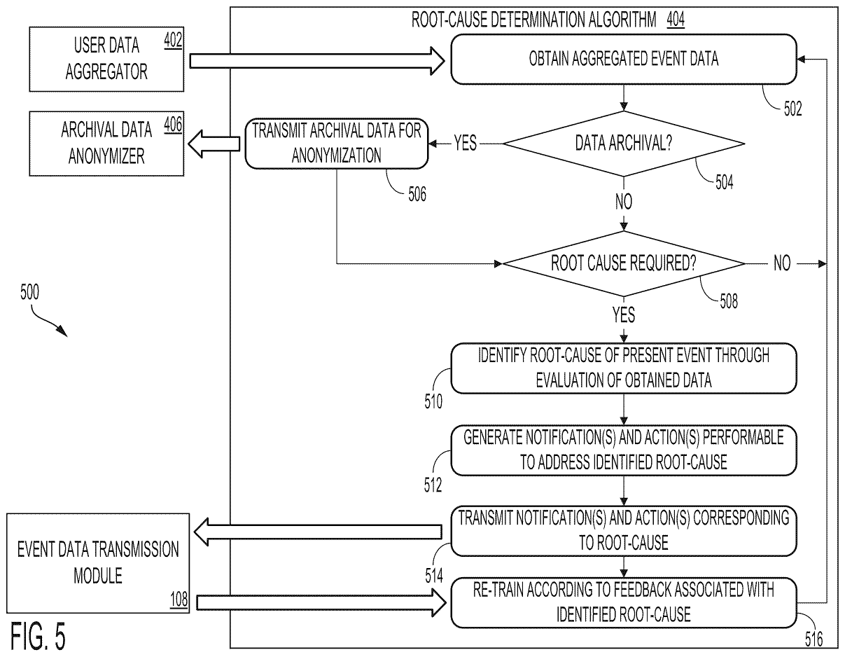

FIG. 5 shows an illustrative example of an environment 500 in which a root-cause determination machine learning algorithm 404 implemented on a user monitoring gateway dynamically processes event data corresponding to a detected user predictive anomaly and historical data corresponding to the user to identify a root-cause of the user predictive anomaly and transmit notifications corresponding to the identified root-cause to different recipients in accordance with at least one embodiment. In the environment 500, the root-cause determination machine learning algorithm 404, at step 502, may obtain aggregated data corresponding to a detected event within a user environment. As noted above, this aggregated data may be obtained from the user data aggregator 402, which may process ambient data from different devices and sensors within the user environment to detect any events occurring within the user environment and to classify these events according to different event categories or types. Through this classification of detected events, the user data aggregator 402 may determine whether a detected event corresponds to a predictive anomaly associated with a user in the user environment. As noted above, the user data aggregator 402, based on the identified type or category of the predictive anomaly detected, may retrieve any historical ambient data corresponding to the identified type or category of the predictive anomaly and that may be processed to determine the root-cause of the predictive anomaly. The user data aggregator 402 may aggregate the event data corresponding to the detected predictive anomaly with the historical ambient data and may use this aggregated data as input to a root-cause determination machine learning algorithm 404.

At step 504, the root-cause determination machine learning algorithm 404 determines whether a data overflow condition has been detected in the user monitoring gateway which may require a data archival operation. As noted above, the user monitoring gateway implements a data storage repository that is configured to store real-time ambient data from the myriad devices and sensors in the user environment. In some instances, the data storage repository may store ambient data from the myriad devices and sensors for a limited period of time (e.g., one week, one month, one year, etc.) to prevent a data overflow within the user monitoring gateway. However, if the user monitoring system detects that the data storage repository has reached a maximum storage amount threshold, the root-cause determination machine learning algorithm 404, at step 506, can transmit archival data from this data storage repository to the archival data anonymizer 406 of the user monitoring system for anonymization of the archival data. The archival data anonymizer 406 may provide this anonymized ambient data to a root-cause analysis system for persistent storage and use. This may provide sufficient data storage for the newly obtained aggregated event data.

If there is no data overflow condition, or once the root-cause determination machine learning algorithm 404 has transmitted the archival data to the archival data anonymizer 406 for anonymization and redundant storage, the root-cause determination machine learning algorithm 404, at step 508, may determine whether a root-cause analysis is required. As noted above, certain types or categories of predictive anomalies may not require a root-cause analysis (e.g., predictive anomalies associated with spontaneous events for which no historical data is available, predictive anomalies that are not associated with a user within the user environment, etc.). If a root-cause analysis is not required, the root-cause determination machine learning algorithm 404 may continue to process any new data supplied by the user data aggregator 402.

If the root-cause determination machine learning algorithm 404 determines that a root-cause for the detected predictive anomaly is required, the root-cause determination machine learning algorithm 404, at step 510, may process the obtained data corresponding to the predictive anomaly to identify one or more root-causes for the predictive anomaly. Similar to the root-cause determination machine learning algorithm 210 described above in connection with FIGS. 2-3, the root-cause determination machine learning algorithm 404 is dynamically trained using a dataset of sample ambient data, sample event data, and sample root-causes corresponding to the sample ambient data and event data. The sample ambient data for each corresponding sample event and root-cause may include a time series of ambient data over a particular period of time. For instance, a sample time series of ambient data may be defined to allow for processing with corresponding event data to determine a root-cause for a detected event. Thus, the root-cause determination machine learning algorithm 404 may process the ambient data and event data obtained from the user data aggregator 402 to generate an output that indicates the one or more root-causes for the predictive anomaly.

Once the root-cause determination machine learning algorithm 404 has identified one or more root-causes for the predictive anomaly, the root-cause determination machine learning algorithm 404, at step 512, may generate one or more notifications and actions performable to address the identified one or more root-causes. Similar to the root-cause determination machine learning algorithm 210 described above in connection with FIGS. 2-3, the root-cause determination machine learning algorithm 404 may be trained to identify possible actions that may be performed to address different root-causes associated with different predictive anomalies. The training of the root-cause determination machine learning algorithm 404 to identify actions performable to address identified root-causes for predictive anomalies may be performed according to the iterative training process described above. The root-cause determination machine learning algorithm 404 may incorporate these identified actions into the notifications corresponding to the predictive anomaly.

At step 514, the root-cause determination machine learning algorithm 404 may transmit these notifications and corresponding actions performable to address the identified root-causes to the event data transmission module 108. As noted above, based on the type or category of predictive anomaly, the event data transmission module 108 may determine how to route the corresponding event data and identified root-causes to other entities. For instance, the event data transmission module 108 may automatically identify the one or more notification recipients for the root-cause notifications according to any applicable user preferences associated with the user. These user preferences may be categorized according to the type of predictive anomaly detected. For example, if the predictive anomaly corresponds to a medical emergency, the event data transmission module 108 may transmit the one or more root-cause notifications to medical personnel that may be able to address the medical emergency. As another illustrative example, if the predictive anomaly corresponds to a user's lack of appetite, the event data transmission module 108 may transmit the one or more root-cause notifications to a caregiver that may use the corresponding data to address any issues related to the user's eating habits.

At step 516, the root-cause determination machine learning algorithm may be re-trained or otherwise updated according to any obtained feedback associated with the identified root-causes for different predictive anomalies. For instance, if the root-cause determination machine learning algorithm 404 incorrectly identifies a particular root-cause for a predictive anomaly and feedback is obtained that indicates the correct root-cause for the predictive anomaly, the feedback may be used to update the dataset used to train the root-cause determination machine learning algorithm 404 such that, for similar predictive anomalies, the root-cause determination machine learning algorithm 404 may be more likely to identify the correct root-cause for the similar predictive anomalies. This feedback may be used to update the dataset used to train the root-cause determination machine learning algorithm 404. For instance, the user monitoring system may add a data point that indicates, for the particular predictive anomaly, the one or more root-causes that should have been identified (as indicated in the obtained feedback). The updated training dataset may be used to evaluate the performance of the root-cause determination machine learning algorithm 404 and, accordingly, generate a new iteration of the root-cause determination machine learning algorithm 404 that more accurately identifies root-causes for detected predictive anomalies. This iterative process may continue until an iteration of the root-cause determination machine learning algorithm 404 is generated that satisfies any applicable accuracy thresholds or other criteria.

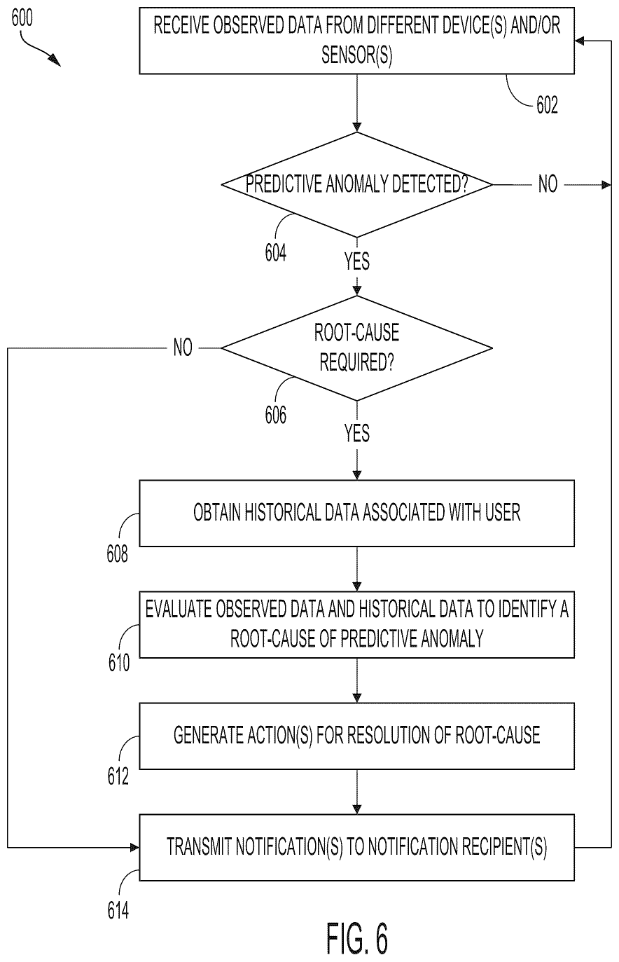

FIG. 6 shows an illustrative example of a process 600 for identifying a root-cause of a detected user anomaly within a user environment and generating actions for addressing the detected user anomaly in accordance with at least one embodiment. The process 600 may be performed by the user monitoring system 104 of the user monitoring gateway 102 described above in connection with FIGS. 4-5. As noted above, the user monitoring system may implement a root-cause determination machine learning algorithm that is dynamically trained to process aggregated ambient and event data corresponding to a detected event to identify the root-cause of a corresponding predictive anomaly. Thus, certain steps of the process 600, as described in greater detail herein, may be performed by this root-cause determination machine learning algorithm.

At step 602, the user monitoring system may receive observed data from different devices and/or sensors implemented in a user environment. As noted above, the user monitoring system may continuously, and in real-time or near real-time, obtain ambient data associated with the user environment from the various devices and sensors implemented in the user environment. The user monitoring system may implement a set of libraries or other resources corresponding to different data formats utilized by different devices and sensors compatible with the user monitoring gateway. This set of libraries or other resources may be used to convert structured, semi-structured and unstructured data from different devices and sensors within the user environment into a consistent format that may be processed to detect any ongoing events within the user environment.

As noted above, the user monitoring system may implement and dynamically train a machine learning algorithm or artificial intelligence to detect, from the obtained ambient data, any activities or other events associated with a user within the user environment. These activities or other events may be routine for a user within the user environment, such as events related to food/drink intake, hygiene, sleep/rest cycles, and the like. However, certain events occurring within the user environment may not be routine and may thus be predictive anomalies that may represent an issue with the user. For example, through the aforementioned machine learning algorithm or artificial intelligence, the user monitoring system may detect an accident within the user environment that may require medical intervention or other assistance. Further, through the aforementioned machine learning algorithm or artificial intelligence, the user monitoring system may detect the absence of ambient data corresponding to different activities within the user environment. As an illustrative example, if ambient data corresponding to a particular room within the user environment is not representative of the presence of a user and/or of an activity occurring within the room, the user monitoring system may generate synthetic data corresponding to the lack of activity within the room. This lack of activity, in some instances, may be indicative of an issue with the user within the user environment.

Based on the identification of different activities and events within the user environment, as well as the classification of these different activities and events, the user monitoring system, at step 604, may determine whether a predictive anomaly has been detected within the user environment. If the user monitoring system does not detect a predictive anomaly occurring within the user environment (e.g., the detected events are routine to the user, etc.), the user monitoring system may continue to receive and process new ambient data from the different devices and/or sensors within the user environment, thereby restarting the process 600. However, if the user monitoring system detects a predictive anomaly occurring within the user environment, the user monitoring system, at step 606, may further determine whether a root-cause or other explanation for the predictive anomaly is required. As noted above, certain types or categories of predictive anomalies do not require a root-cause analysis. Returning to an earlier illustrative example, predictive anomalies associated with spontaneous events for which no historical data is available (e.g., major power outages, natural disasters, etc.) may not require root-cause analysis. Further, predictive anomalies that are not associated with a user within the user environment (e.g., predictive anomalies associated with the functionality of devices and/or sensors that are not user-specific) may not require root-cause analysis.

If the user monitoring system determines that a root-cause determination for the detected event is not required, the user monitoring system, at step 614, may transmit the event data corresponding to the detected event for delivery to one or more notification recipients. For instance, the user monitoring system may provide this event data to an event data transmission module implemented by the user monitoring gateway. The event data transmission module may determine how to route the event data to other entities based on a set of preferences corresponding to the particular user associated with the event. For example, if the event data corresponds to a predictive anomaly associated with the user's eating habits, the event data transmission module may evaluate the user preferences associated with the user and determine that, for this type of predictive anomaly, the event data is to be transmitted to a caregiver associated with the user. The caregiver may use this data to further evaluate the user to determine the cause of the predictive anomaly. Once the user monitoring system has transmitted the event data to the one or more notification recipients, the user monitoring system may continue to receive new observed data from different devices and/or sensors within the user environment (step 602) and continue to process this new observed data to detect any new or ongoing predictive anomalies, thereby restarting the process 600.

If the user monitoring system determines that a root-cause for the predictive anomaly is required, the user monitoring system, at step 608, may obtain historical data associated with the user. For instance, the user monitoring system may query the data storage repository maintained by the user monitoring gateway and/or the root-cause analysis system (if anonymized data is redundantly stored in the root-cause analysis system according to data overflow issues) to obtain historical user data that may be processed to determine the root-cause of the predictive anomaly. The query from user monitoring system, in some instances, may include an identifier corresponding to the user associated with the predictive anomaly. Additionally, or alternatively, the query from the user monitoring system may include the one or more types of data that may be required to determine the root-cause of the predictive anomaly. To determine what data may be required to identify a possible root-cause for a predictive anomaly, the user monitoring system may implement a machine learning algorithm or artificial intelligence that is dynamically trained to process current ambient and event data corresponding to the predictive anomaly to identify the types of data that may be analyzed to determine a root-cause for the predictive anomaly. Through the machine learning algorithm or artificial intelligence, the user monitoring system may perform clustering or classification of the event data corresponding to the predictive anomaly to identify the type or category of event detected and, accordingly, identify what data may be required to determine the root-cause of the detected event and corresponding predictive anomaly.

At step 610, the user monitoring system may evaluate the observed data corresponding to the predictive anomaly and the historical data to identify one or more root-causes of the predictive anomaly. As noted above, the user monitoring system may implement and dynamically train a root-cause determination machine learning algorithm to identify the root-causes of different predictive anomalies based on the event data corresponding to these predictive anomalies and any available historical data corresponding to the user associated with the predictive anomalies. Accordingly, the user monitoring system may use the observed data corresponding to the predictive anomaly and the historical obtained at step 610 as input to the root-cause determination machine learning algorithm to identify one or more root-causes for the detected predictive anomaly.

At step 612, based on the one or more root-causes of the predictive anomaly, the user monitoring system may generate one or more actions that may be performed to resolve these one or more root-causes and, thus, the predictive anomaly. As noted above, the root-cause determination machine learning algorithm may be further trained using a dataset of sample predictive anomalies (e.g., historical or actual predictive anomalies, hypothetical predictive anomalies, combinations of historical/actual and hypothetical predictive anomalies, etc.), sample root-causes associated with the sample predictive anomalies and known actions performable to address the sample root-causes of the sample predictive anomalies. The training of the root-cause determination machine learning algorithm to identify actions performable to address identified root-causes for predictive anomalies may be performed according to the iterative training process described above. Thus, in addition to identifying the one or more root-causes for the predictive anomaly, the root-cause determination machine learning algorithm may automatically identify one or more actions performable to address these one or more root-causes.

At step 614, the user monitoring system may transmit one or more notifications including the generated actions and the event data corresponding to the predictive anomaly for delivery to one or more notification recipients. As noted above, the user monitoring system may provide these notifications to an event data transmission module implemented by the user monitoring gateway. The event data transmission module may determine how to route the notifications to other entities based on the set of preferences corresponding to the particular user associated with the event. Once the user monitoring system has transmitted these one or more notifications to the one or more notification recipients, the user monitoring system may continue to receive new observed data from different devices and/or sensors within the user environment (step 602) and continue to process this new observed data to detect any new or ongoing predictive anomalies, thereby restarting the process 600.

It should be noted that the process 600 may be performed continuously and simultaneously for different ambient data as the ambient data is received. For instance, the user monitoring system may continuously and simultaneously process different ambient data from the different devices and/or sensors in the user environment in real-time or near real-time as the different ambient data is received to detect any events occurring within the user environment and determine whether these events correspond to predictive anomalies associated with users in the user environment. Further, as these predictive anomalies are detected, the user monitoring system may continuously and simultaneously process the data corresponding to these different predictive anomalies to dynamically identify the root-causes of these predictive anomalies and identify actions performable to address these root-causes. Thus, the user monitoring system may continuously and simultaneously process any amount of ambient data from different sensors and/or devices within the user environment in real-time or near real-time as the ambient data is received to dynamically detect events, identify any predictive anomalies from these detected events, identify the root-causes of these predictive anomalies, and identify actions that may be performed to address these root-causes.

In some embodiments, certain operations of the process 600 can be performed by different devices or sensors within the user environment and that are in communication with the user monitoring system. For example, in some instances, a device or sensor within the user environment may dynamically process ambient data collected by the device or sensor to detect any predictive anomalies occurring within the user environment. This initial processing of the ambient data may be performed through machine learning algorithms or artificial intelligence processes executing on the device or sensor. Any predictive anomalies detected by the device or sensor, along with the associated ambient data, may be transmitted to the user monitoring system, which may continue to perform the process 600 to identify root-causes associated with the predictive anomaly and generate actions performable to address the predictive anomaly. In some instances, a device or sensor may have sufficient computational capability to identify rudimentary root-causes for detected predictive anomalies. If a rudimentary root-cause cannot be identified, the device or sensor may then transmit the event data associated with the predictive anomaly to the user monitoring system for continuation of the process 600. Otherwise, if the device or sensor identifies a rudimentary root-cause for the predictive anomaly, the device or sensor may transmit the event data corresponding to the predictive anomaly and the identified root-cause to the user monitoring system for delivery to one or more notification recipients as described above.

In an embodiment, the user monitoring system, based on the predictive anomaly detected and the identified root-cause for the predictive anomaly, can perform additional operations to calibrate or otherwise adjust any of the myriad devices and/or sensors within the user environment and from which ambient data is obtained. For instance, if the user monitoring system determines that the root-cause of a predictive anomaly is faulty ambient data being generated by a particular sensor or device within the user environment, the user monitoring system may transmit executable instructions to the sensor or device to adjust or calibrate the sensor or device. In some instances, the user monitoring system may dynamically adjust how ambient data is processed for detecting predictive anomalies based on identified predictive anomalies and corresponding root-causes. For example, if the user monitoring system detects a predictive anomaly as a result of a decrease in the user's blood pressure, but determines that the root-cause of this decrease is the introduction of a new blood pressure medication that otherwise has no negative impact on the user, the user monitoring system may adjust one or more thresholds corresponding to the processing of ambient data from a blood pressure monitor such that similar ambient data does not cause the user monitoring system to detect and event and corresponding predictive anomaly for this change in user blood pressure.

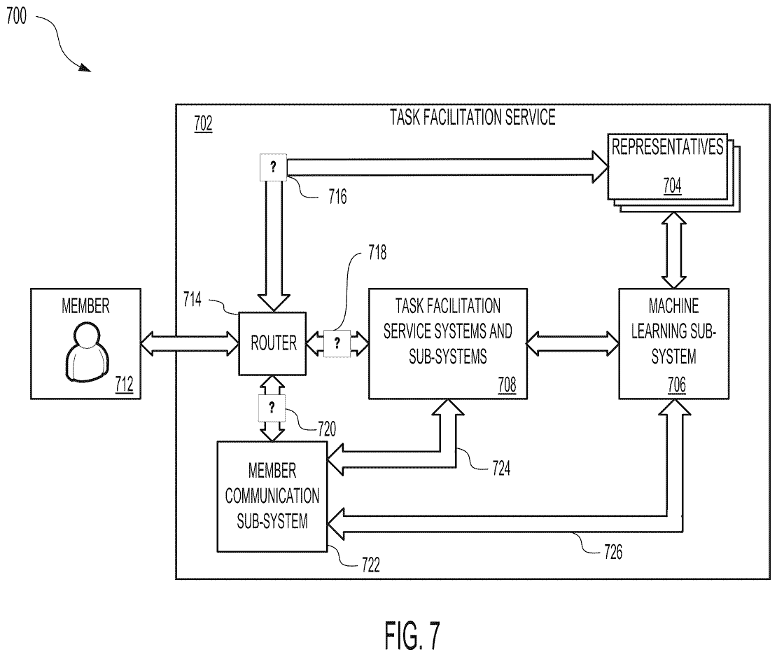

FIG. 7 shows an illustrative example of an environment 700 in which communications with members are processed in accordance with at least one embodiment. In an embodiment, operations performed by representatives 704 are partially and/or fully performed using one or more machine learning algorithms, artificial intelligence systems and/or computational models. For example, as the representatives 704 perform or otherwise coordinate performance of tasks on behalf of a member 712, the task facilitation service 702 may update a profile of the member 712 and/or a computational model of the profile of the member 712.

In an embodiment, as the representatives 704 perform or otherwise coordinate performance of tasks on behalf of a member 712, the task facilitation service 702 updates a profile of the member 712 and/or a computational model of the profile of the member 712 continuously. For example, as a member 712 communicates with a system of the task facilitation service 702, the task facilitation service 702 may update the profile of the member 712 and/or a computational model of the profile of the member 712 continuously during the course of the interaction.

In an embodiment, as the representatives 704 perform or otherwise coordinate performance of tasks on behalf of a member 712, the task facilitation service 702 updates a profile of the member 712 and/or a computational model of the profile of the member 712 dynamically. For example, as a task is performed on behalf of a member 712, a vendor performing the task may provide regular updates to the task facilitation service 702 and the task facilitation service 702 may update the profile of the member 712 and/or a computational model of the profile of the member 712 dynamically at each update from the vendor.

In an embodiment, as the representatives 704 perform or otherwise coordinate performance of tasks on behalf of a member 712, the task facilitation service 702 updates a profile of the member 712 and/or a computational model of the profile of the member 712 automatically. For example, when a proposal is generated for the member, the task facilitation service 702 may update the profile of the member 712 and/or a computational model of the profile of the member 712 automatically as part of the proposal generation process.

In an embodiment, as the representatives 704 perform or otherwise coordinate performance of tasks on behalf of a member 712, the task facilitation service 702 updates a profile of the member 712 and/or a computational model of the profile of the member 712 in real-time. For example, when a member 712 accepts a proposal, the task facilitation service 702 may update the profile of the member 712 and/or a computational model of the profile of the member 712 at the time that the proposal acceptance is provided, rather than delaying the update.

In an embodiment, the task facilitation service 702 updates a profile of the member 712 and/or a computational model of the profile of the member 712 using a machine learning sub-system 706 of the task facilitation service 702. In an embodiment, a machine learning sub-system 706 is a component of the task facilitation service 702 that is configured to implement machine learning algorithms, artificial intelligence systems, and/or computation models. In an example, a machine learning sub-system 706 may use various algorithms to train a machine learning model using sample and/or live data. Additionally, a machine learning sub-system 706 may update the machine learning model as new data is received. In another example, the machine learning sub-system 706 may train and/or update various artificial intelligence systems or generate, train and/or update various computational models. For example, a computational model of the profile of the member 712 may be generated, trained and/or updated by the machine learning sub-system 706 as new information is received about the member 712.

In an embodiment, after the profile of the member 712 and/or a computational model of the profile of the member 712 has been updated over a period of time (e.g., six months, a year, etc.) and/or over a set of tasks (e.g., twenty tasks, thirty tasks, etc.), systems of the task facilitation service 702 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 702 (e.g., a task recommendation system) can automatically communicate with the member 712 to obtain any additional information needed and can also generate proposals that may be presented to the member 712 for performance of these tasks.

In the example illustrated in FIG. 7, communications between the member 712 and the task facilitation service 702 may be routed to one or more entities within the task facilitation service 702. The example illustrated in FIG. 7 shows a communication router 714 (referred to in the illustration as a “router”) however, as may be contemplated and as illustrated in FIG. 7, the router 714 is an abstract representation of one or more techniques for routing communications between entities. Accordingly, communications from the member 712 to the task facilitation service 702 may be routed to one or more entities of the task facilitation service and communications from the one or more entities of the task facilitation service 702 may be routed back to the member 712.

In the example illustrated in FIG. 7, the representatives 704 can monitor communications between task facilitation service systems and/or sub-systems 708 and the member 712 to ensure that the interaction maintains a positive polarity as described herein because the communications can be routed 716 to the representatives 704 and also routed 718 to task facilitation service systems and/or sub-systems 708. For example, if a member 712 is interacting with the task recommendation system, the representatives 704 can determine whether the member 712 is satisfied with the interaction. If the representatives 704 determine that the conversation has a negative polarity (e.g., that the member 712 is not satisfied with the interaction), the representatives 704 may intervene to improve the interaction.

Similarly, other interactions between task facilitation service systems and/or sub-systems 708 and the member 712 may be routed 720 to a member communication sub-system 722 which may be configured to monitor the interactions between task facilitation service systems and/or sub-systems 708 and the member 712. In an embodiment, the member communication sub-system 722 can be configured to intercept the interactions between task facilitation service systems and/or sub-systems 708 and the member 712 (using, for example, the router 714). In such an embodiment, all such interactions can be routed 720 between the member 712 and the member communication sub-system 722 and can be routed 724 between the member communication sub-system 722 and the task facilitation service systems and/or sub-systems 708. In such an embodiment, interactions between the task facilitation service systems and/or sub-systems 708 and the member 712 may not be routed 718 directly. In such an embodiment, the representatives 704 may still monitor interactions between task facilitation service systems and/or sub-systems 708 and the member 712 to ensure that the interaction maintains a positive polarity as described above (e.g., by routing 716 the interactions to the representatives 704).

In an embodiment, the representatives 704 can interact with the machine learning sub-system 706 to update the profile of the member indicating changing member preferences based on an interaction between the representatives 704 the member 712. In an embodiment, the task facilitation service systems and/or sub-systems 708 can interact with the machine learning sub-system 706 to update the profile of the member when, for example, a proposal is accepted or rejected. Additionally, as illustrated in FIG. 7, the interactions between the task facilitation service 702 and the member 712 can be additionally routed 726 between the member communication sub-system 722 and the machine learning sub-system 706. Accordingly, interactions between the member 712 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 708 can update the profile of the member 712 and/or a computational model of the profile of the member 712 continuously, dynamically, automatically, and/or in real-time. For example, task facilitation service systems and/or sub-systems 708 can update the profile of the member 712 and/or a computational model of the profile of the member 712 using the machine learning sub-system 706 as described herein. Accordingly, task facilitation service systems and/or sub-systems 708 can update the profile of the member 712 and/or a computational model of the profile of the member 712 to provide up-to-date information about the member based on the member's automatic interaction with the task facilitation service 702, based on the member's interaction with the representative 704, and/or based on tasks performed on behalf of the member 712 over time. This information may also be updated continuously, automatically, dynamically, and/or in real-time as tasks and/or proposals are created, proposed, and performed for the member 712. This information may also be used by the task facilitation service 702 to anticipate, identify, and present appropriate or intelligent interactions with the member 712 (e.g., in response to member 712 queries, needs, and/or goals).

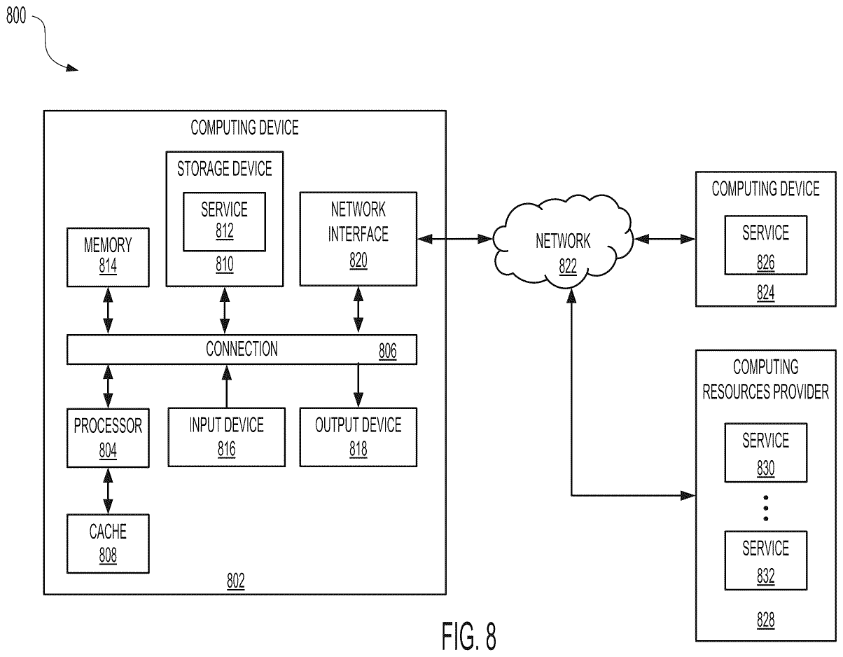

FIG. 8 illustrates a computing system architecture 800, including various components in electrical communication with each other, in accordance with some embodiments. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as arithmetic logic units (ALU), floating point units (FPU), graphics processing units (GPU), physics processing units (PPU), neural processing units (NPU), tensor processing units (TPU), digital system processing (DSP) units, or combinations of these and/or other such processing units. The processor 804 can be implemented through different processor architectures, such as Reduced Instruction Set Computing (RISC) architectures (e.g., RISC-V, etc.), Advanced RISC Machine (ARM) architectures, and the like.

The computing device 802 can further include one or more dedicated processors that are configured to exclusively perform machine learning algorithm and/or artificial intelligence calculations and processes. Similar to the processor 804, the one or more dedicated processors implemented on the computing device 802 can be a completely self-contained computing system, containing multiple cores or processors, connectors (e.g., buses), memory, memory controllers, caches, etc. In some embodiments, such a self-contained computing system with multiple cores is symmetric or asymmetric. The one or more dedicated processors can include multiple elements such as a core, one or more registers, and one or more processing units such as ALUs, FPUs, GPUs, PPUs, NPUs, TPUs, DSP units, or combinations of these and/or other such processing units. Similar to the processor 804, these one or more dedicated processors can be implemented through different processor architectures, such as RISC architectures (e.g., RISC-V, etc.), ARM architectures, and the like. This implementation of dedicated processors to exclusively perform machine learning algorithm and/or artificial intelligence calculations and processes provides acceleration of the machine learning algorithm and/or artificial intelligence processes, thereby reducing computing device latency while supporting the operations of the computing device 802 as described herein.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In an embodiment, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed processed for generating and executing experience recommendations can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. The processor 804 can include multiple elements such as a core, one or more registers, and one or more processing units such as ALUs, FPUs, GPUs, PPUs, NPUs, TPUs, DSP units, or combinations of these and/or other such processing units. The processor 804, as noted above, can be implemented through different processor architectures, such as RISC architectures (e.g., RISC-V, etc.), ARM architectures, and the like. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described above, the connector 806 (or bus) can also couple the processor 804 to the storage device 810, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/O devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, dedicated processors to exclusively perform and accelerate machine learning algorithm and/or artificial intelligence calculations and processes, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® or Bluetooth® Low Energy (BLE) network, a virtual private network (VPN), a public switched telephone network, an infrared (IR) network, an internet of things (IoT network), a Zigbee network, a Z-Wave network, or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), Z-Wave, Zigbee, Matter, Message Queuing Telemetry Transport (MQTT), WebSocket, and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), Protocol Buffers (Protobuf), MQTT, Matter, and other such protocols and/or structured languages, including any variants implementing Secure Sockets Layer (SSL), Transport Layer Security (TLS), or any other security protocols. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g. network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 802) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 3 and 5-6). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system or simulator, such as a virtual version of one of the aforementioned devices that may be hosted on another computer device such as the computer device 802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
continuously receiving ambient data associated with a user, wherein the ambient data is continuously received through a set of communications channels between different sensors and a gateway device;
obtaining an anomaly notification corresponding to an anomaly associated with the user, wherein the anomaly notification indicates a current user state for which a root-cause is unknown;
processing the ambient data and historical ambient data associated with the user through a machine learning algorithm to identify one or more root-causes of the anomaly, wherein the machine learning algorithm is trained using a dataset of sample ambient data, sample anomalies, and sample root-causes associated with the sample anomalies;
transmitting a root-cause notification corresponding to the one or more root-causes, wherein when the root-cause notification is received by one or more recipients, the one or more recipients perform one or more actions to address the anomaly according to the one or more root-causes; and
continuously monitoring new ambient data associated with the user to determine whether the one or more actions have addressed the anomaly and the one or more root-causes.

2. The computer-implemented method of claim 1, further comprising:
anonymizing the ambient data and the historical ambient data to generate anonymized data; and
dynamically updating the dataset to incorporate the anonymized data, wherein the updated dataset is used to update the machine learning algorithm.

3. The computer-implemented method of claim 1, wherein:
the one or more recipients include a device, wherein the device is connected to the gateway device through a wireless communications channel; and
the root-cause notification includes one or more executable instructions that, when executed by the device, cause the device to perform the one or more actions.

4. The computer-implemented method of claim 1, further comprising:
determining, based on the new ambient data, that the one or more actions have not addressed the anomaly; and
transmitting a new notification to indicate that the anomaly has not been addressed, wherein the new notification includes the new ambient data.

5. The computer-implemented method of claim 1, further comprising:
determining, based on the new ambient data, that the one or more actions have not addressed the anomaly; and
identifying new actions performable to address the anomaly.

6. The computer-implemented method of claim 1, wherein the anomaly notification is obtained through a medical entity associated with the user.

7. The computer-implemented method of claim 1, wherein the different sensors include a set of Internet-of-Things (IoT) devices associated with the user.

8. A system, comprising:
one or more processors; and
memory storing thereon instructions that, as a result of being executed by the one or more processors, cause the system to:
continuously receive ambient data associated with a user, wherein the ambient data is continuously received through a set of communications channels between different sensors and a gateway device;
obtain an anomaly notification corresponding to an anomaly associated with the user, wherein the anomaly notification indicates a current user state for which a root-cause is unknown;
process the ambient data and historical ambient data associated with the user through a machine learning algorithm to identify one or more root-causes of the anomaly, wherein the machine learning algorithm is trained using a dataset of sample ambient data, sample anomalies, and sample root-causes associated with the sample anomalies;
transmit a root-cause notification corresponding to the one or more root-causes, wherein when the root-cause notification is received by one or more recipients, the one or more recipients perform one or more actions to address the anomaly according to the one or more root-causes; and
continuously monitor new ambient data associated with the user to determine whether the one or more actions have addressed the anomaly and the one or more root-causes.

9. The system of claim 8, wherein the instructions further cause the system to:
anonymize the ambient data and the historical ambient data to generate anonymized data; and
dynamically update the dataset to incorporate the anonymized data, wherein the updated dataset is used to update the machine learning algorithm.

10. The system of claim 8, wherein:
the one or more recipients include a device, wherein the device is connected to the gateway device through a wireless communications channel; and
the root-cause notification includes one or more executable instructions that, when executed by the device, cause the device to perform the one or more actions.

11. The system of claim 8, wherein the instructions further cause the system to:
determine, based on the new ambient data, that the one or more actions have not addressed the anomaly; and
transmit a new notification to indicate that the anomaly has not been addressed, wherein the new notification includes the new ambient data.

12. The system of claim 8, wherein the instructions further cause the system to:
determine, based on the new ambient data, that the one or more actions have not addressed the anomaly; and
identify new actions performable to address the anomaly.

13. The system of claim 8, wherein the anomaly notification is obtained through a medical entity associated with the user.

14. The system of claim 8, wherein the different sensors include a set of Internet-of-Things (IoT) devices associated with the user.

15. A non-transitory computer-readable storage medium storing thereon executable instructions that, as a result of being executed by one or more processors of a computer system, cause the computer system to:
continuously receive ambient data associated with a user, wherein the ambient data is continuously received through a set of communications channels between different sensors and a gateway device;
obtain an anomaly notification corresponding to an anomaly associated with the user, wherein the anomaly notification indicates a current user state for which a root-cause is unknown;
process the ambient data and historical ambient data associated with the user through a machine learning algorithm to identify one or more root-causes of the anomaly, wherein the machine learning algorithm is trained using a dataset of sample ambient data, sample anomalies, and sample root-causes associated with the sample anomalies;
transmit a root-cause notification corresponding to the one or more root-causes, wherein when the root-cause notification is received by one or more recipients, the one or more recipients perform one or more actions to address the anomaly according to the one or more root-causes; and
continuously monitor new ambient data associated with the user to determine whether the one or more actions have addressed the anomaly and the one or more root-causes.

16. The non-transitory computer-readable storage medium of claim 15, wherein the executable instructions further cause the computer system to:
anonymize the ambient data and the historical ambient data to generate anonymized data; and
dynamically update the dataset to incorporate the anonymized data, wherein the updated dataset is used to update the machine learning algorithm.

17. The non-transitory computer-readable storage medium of claim 15, wherein:
the one or more recipients include a device, wherein the device is connected to the gateway device through a wireless communications channel; and
the root-cause notification includes one or more new executable instructions that, when executed by the device, cause the device to perform the one or more actions.

18. The non-transitory computer-readable storage medium of claim 15, wherein the executable instructions further cause the computer system to:
determine, based on the new ambient data, that the one or more actions have not addressed the anomaly; and
transmit a new notification to indicate that the anomaly has not been addressed, wherein the new notification includes the new ambient data.

19. The non-transitory computer-readable storage medium of claim 15, wherein the executable instructions further cause the computer system to:
determine, based on the new ambient data, that the one or more actions have not addressed the anomaly; and
identify new actions performable to address the anomaly.

20. The non-transitory computer-readable storage medium of claim 15, wherein the anomaly notification is obtained through a medical entity associated with the user.

21. The non-transitory computer-readable storage medium of claim 15, wherein the different sensors include a set of Internet-of-Things (IoT) devices associated with the user.
